(19) United States
(12) Patent Application Publication
(10) Pub. No.: US 2012/0147961 A1
(43) Pub. Date: Jun. 14, 2012

(54) USE OF MOTION VECTORS IN EVALUATING GEOMETRIC PARTITIONING MODES

(75) Inventors: Liwei Guo, San Diego, CA (US); Marta Karczewicz, San Diego, CA (US); Peisong Chen, San Diego, CA (US)

(73) Assignee: QUALCOMM INCORPORATED, San Diego, CA (US)

(21) Appl. No.: 13/302,539

(22) Filed: Nov. 22, 2011

Related U.S. Application Data
(60) Provisional application No. 61/421,581, filed on Dec. 9, 2010.
(60) Provisional application No. 61/450,450, filed on Mar. 8, 2011.

(51) Int. Cl. H04N 7/28

(52) U.S. Cl. 375/240.16; 375/E07.25

(57) ABSTRACT

During a video encoding process, rectangular prediction units (PUs) for a coding unit (CU) are generated. Furthermore, a geometric partitioning mode is used to generate a first and a second geometric PU for the CU. The first and second geometric PUs are associated with different geometric partitions of a sample block of the CU. One of the rectangular PUs is identified as overlapping the first geometric PU. The motion vector of the identified rectangular PU is used to identify a given area of a reference frame. The given area of a reference frame is then used as a starting point of a search to identify a reference sample for the first geometric PU. A motion vector for the first geometric PU indicates a position of the reference sample relative to a position of the first geometric PU. A prediction block is generated using the motion vector for first geometric PU.

### CROSS-REFERENCE TO RELATED APPLICATIONS

This application claims the benefit of U.S. Provisional Application No. 61/421,581, filed Dec. 9, 2010 and U.S. Provisional Application No. 61/450,450, filed Mar. 8, 2011, the entire content of each being hereby incorporated by reference.

### TECHNICAL FIELD

This disclosure relates to video coding.

### BACKGROUND

Digital video capabilities may be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into blocks. Each block may be further partitioned. Blocks in an intra-coded (I) frame or slice are encoded using spatial prediction with respect to neighboring blocks. Blocks in an inter-coded (P or B) frame or slice may use spatial prediction with respect to neighboring blocks in the same frame or slice or temporal prediction with respect to other reference frames.

### SUMMARY

Generally, the techniques described in disclosure may reduce the computational complexity of choosing a prediction block from among prediction blocks generated using geometric partitioning modes. For example, the techniques may provide for the use of motion vectors for rectangle-shaped prediction units (PUs) to potentially decrease the number of computational operations performed to find reference samples for geometrically-shaped PUs. Because it may require fewer computational operations to find the reference samples for the geometrically-shaped PUs, the overall computational complexity of choosing a prediction block may be reduced.

In one example, this disclosure describes a method of encoding video data. The method comprises using a first rectangular partitioning mode to generate a first and a second rectangular PU for a coding unit (CU) in the video data. A sample block of the CU is rectangularly partitioned between the first and the second rectangular PUs. The method also comprises using a geometric partitioning mode to generate a first and a second geometric PU for the CU. The first and second geometric PUs are associated with different geometric partitions of the sample block of the CU. In addition, the method comprises identifying the first rectangular PU as overlapping the first geometric PU. The method also comprises after identifying the first rectangular PU as overlapping the first geometric PU, using a motion vector of the first rectangular PU to identify a given area of a reference frame. In addition, the method comprises using the given area within the reference frame as a starting point for searching the reference frame for a first reference sample. The first reference sample is an area of the reference frame that corresponds to the first geometric PU. In addition, the method comprises generating a motion vector for the first geometric PU. The motion vector for the first geometric PU indicates a position of the first reference sample relative to a position of the first geometric PU. The method also comprises generating a prediction block for the CU using the motion vector for the first geometric PU.

In another example, this disclosure describes a computing device that comprises a processor configured to use a first rectangular partitioning mode to generate a first and a second rectangular PU for a CU in video data, a sample block of the CU being rectangularly partitioned between the first and the second rectangular PUs. The processor is also configured to use a geometric partitioning mode to generate a first and a second geometric PU for the CU, the first and second geometric PUs associated with different geometric partitions of the sample block of the CU. In addition, the processor is configured to identify the first rectangular PU as overlapping the first geometric PU. The processor is also configured such that after identifying the first rectangular PU as overlapping the first geometric PU, the processors uses a motion vector of the first rectangular PU to identify a given area of a reference frame. In addition, the processor is configured to use the given area within the reference frame as a starting point for searching the reference frame for a first reference sample, the first reference sample being an area of the reference frame that corresponds to the first geometric PU. The processor is also configured to generate a motion vector for the first geometric PU. The motion vector for the first geometric PU indicates a position of the first reference sample relative to a position of the first geometric PU. In addition, the processor is configured to generate a prediction block for the CU using the motion vector for the first geometric PU.

In another example, this disclosure describes a computing device comprising means for using a first rectangular partitioning mode to generate a first and a second rectangular prediction unit (PU) for a coding unit (CU) in the video data, a sample block of the CU being rectangularly partitioned between the first and the second rectangular PUs. The computing device also comprises means for using a geometric partitioning mode to generate a first and a second geometric PU for the CU, the first and second geometric PUs associated with different geometric partitions of the sample block of the CU. In addition, the computing device comprises means for identifying the first rectangular PU as overlapping the first geometric PU. The computing device also comprises means for using a motion vector of the first rectangular PU to identify a given area of a reference frame after identifying the first rectangular PU as overlapping the first geometric PU. In addition, the computing device comprises means for using the given area within the reference frame as a starting point for searching the reference frame for a first reference sample, the first reference sample being an area of the reference frame that corresponds to the first geometric PU. The computing device also comprises means for generating a motion vector for the first geometric PU, the motion vector for the first geometric PU indicating a position of the first reference sample relative to a position of the first geometric PU. Furthermore, the computing device comprises means for generating a prediction block for the CU using the motion vector for the first geometric PU.

In another example, this disclosure describes a computer program product that comprises a computer-readable storage medium having instructions stored thereon that cause one or more processors to use a first rectangular partitioning mode to generate a first and a second rectangular prediction unit (PU) for a coding unit (CU) in the video data, a sample block of the CU being rectangularly partitioned between the first and the second rectangular PUs. The instructions also cause the one or more processors to use a geometric partitioning mode to generate a first and a second geometric PU for the CU, the first and second geometric PUs associated with different geometric partitions of the sample block of the CU. The instructions also cause the one or more processors to identify the first rectangular PU as overlapping the first geometric PU. The instructions also cause the one or more processors to, after identifying the first rectangular PU as overlapping the first geometric PU, use a motion vector of the first rectangular PU to identify a given area of a reference frame. The instructions also cause the one or more processors to use the given area within the reference frame as a starting point for searching the reference frame for a first reference sample, the first reference sample being an area of the reference frame that corresponds to the first geometric PU. In addition, the instructions cause the one or more processors to generate a motion vector for the first geometric PU, the motion vector for the first geometric PU indicating a position of the first reference sample relative to a position of the first geometric PU. The instructions also cause the one or more processors to generate a prediction block for the CU using the motion vector for the first geometric PU.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram that illustrates an example multimedia encoding and decoding system.

FIG. 2 is a conceptual diagram that illustrates an example series of frames in a video.

FIG. 3 is a block diagram that illustrates an example configuration of an encoding unit.

FIG. 4 is a conceptual diagram that illustrates an example frame partitioned into treeblocks.

FIG. 5 is a conceptual diagram that illustrates a further example partitioning of treeblocks.

FIG. 6 is a block diagram that illustrates an example configuration of an inter-prediction unit.

FIG. 7 is a block diagram that illustrates an example configuration of a decoding unit.

FIG. 8 is a flowchart that illustrates an example inter-frame coding operation performed by an inter-prediction unit on a CU.

FIG. 9 is a conceptual diagram that illustrates example rectangular partitioning modes.

FIG. 10 is a conceptual diagram that illustrates example geometric partitioning modes.

FIG. 11 is a flowchart that illustrates an example operation performed by the inter-prediction unit to generate a prediction block for a CU.

FIG. 12 is a flowchart that illustrates another example operation performed by the inter-prediction unit to generate a prediction block for a CU.

FIG. 13A is a flowchart that illustrates another example operation performed by the inter-prediction unit to generate a prediction block for a CU.

FIG. 13B is a flowchart that illustrates an example portion of the operation of FIG. 13A to generate a motion vector for a geometric PU.

FIG. 14 is a flowchart that illustrates another example operation performed by the inter-prediction unit to generate a prediction block for a CU.

FIG. 15 is a flowchart that illustrates another example operation performed by the inter-prediction unit to generate a prediction block for a CU.

FIG. 16 is a conceptual diagram that illustrates an example sample block.

FIG. 17 is a conceptual diagram that illustrates searching for a reference sample within a reference frame.

### DETAILED DESCRIPTION

The attached drawings illustrate examples. Elements indicated by reference numbers in the attached drawings correspond to elements indicated by like reference numbers in the following description. In the attached drawings, ellipses indicate the presence of one or more elements similar to those separated by the ellipses. Alphabetical suffixes on reference numbers for similar elements are not intended to indicate the presence of particular numbers of the elements. In this disclosure, elements having names that start with ordinal words (e.g., “first,” “second,” “third,” and so) do not necessarily imply that the elements have a particular order. Rather, such ordinal words may merely be used to refer to different elements of the same or similar kind.

A frame of video data is associated with one or more blocks of samples. In this disclosure, the term “sample” may refer to a value defining a component of a pixel, such as a luma or a chroma component of the pixel. In this disclosure, a two-dimensional array of such samples may be referred to as a “sample block.” Each sample block of the frame can specify different components of the pixels in the frame.

An encoder may first partition a frame into “slices.” A slice is a term used generally to refer to independently decodable portions of the frame. The encoder may next partition these slices into “treeblocks.” A treeblock may also be referred to as a largest coding unit (LCU). The encoder may partition each of the treeblocks into a hierarchy of progressively smaller sample blocks, which when illustrated may be represented as a hierarchical tree structure, hence the name “treeblocks.” Partitioning treeblocks in this way may enable the encoder to capture motion of different sizes. Each undivided sample block corresponds to a different coding unit (CU). For ease of explanation, this disclosure may refer to the sample block corresponding to a CU as the sample block of the CU.

The encoder can generate one or more prediction units (PUs) for each of the CUs. The encoder can generate the PUs for a CU by partitioning the sample block of the CU into prediction areas. The encoder may then perform a motion estimation operation with respect each PU of the CU. When the encoder performs the motion estimation operation with respect to a PU, the encoder generates motion information for the PU. The encoder performs a motion compensation operation that uses the motion information determined for the PUs to generate a prediction block for the CU. The encoder compares the prediction block of the CU with the original sample block of the CU to determine residual data for the CU.

The encoder can generate the PUs for a CU by partitioning the sample block of the CU into prediction areas according to a rectangular or geometric partitioning mode. When the encoder uses geometric partitioning modes to generate the PUs for the CU, the encoder partitions the sample block of the CU into two rectangular or non-rectangular prediction areas. Each of the two prediction areas may have its own motion information. When the encoder uses geometric partitioning modes to partition the sample block of the CU, the motion of the video data may be better described. Because an encoder may be able to use many geometric partitioning modes, it may be computational complex for the encoder to identify a geometric partitioning mode that produces encoded data for the CU having a high coding efficiency and visual quality.

This disclosure describes techniques that may be able to lower the computational complexity in evaluating geometric partitioning modes. For example, the techniques of this disclosure provide for the identifying a rectangular PU that overlaps a geometric PU. The encoder may use a motion vector of the rectangular PU to identify a portion of a reference frame. In this example, the encoder may then use the identified portion of the reference frame as a starting point of a search for a reference sample for the geometric PU. This may reduce the computational complexity of finding the reference sample for the geometric PU, and thus reduce the computational complexity of evaluating geometric partitioning modes.

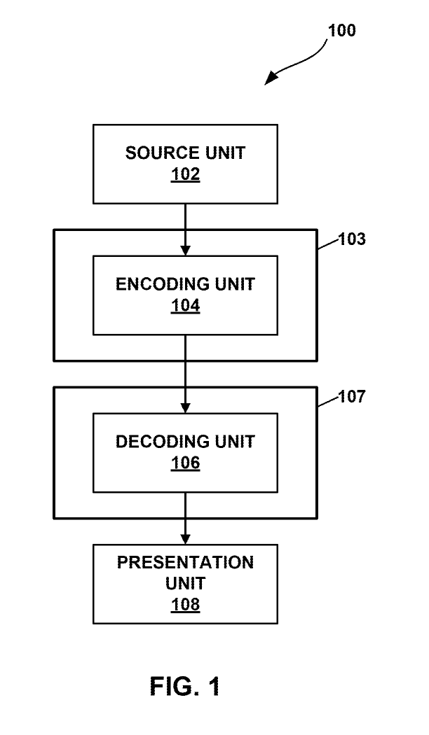

FIG. 1 is a block diagram that illustrates an example multimedia encoding and decoding system 100. Multimedia encoding and decoding system 100 captures video data, encodes the captured video data, transmits the encoded video data, decodes the encoded video data, and then plays back the decoded video data.

Multimedia encoding and decoding system 100 comprises a source unit 102, an encoding unit 104, a decoding unit 106, and a presentation unit 108. Source unit 102 generates video data. Encoding unit 104 encodes the video data. Decoding unit 106 decodes the encoded video data. Presentation unit 108 presents the decoded video data.

One or more computing devices implement source unit 102, encoding unit 104, decoding unit 106, and presentation unit 108. In this disclosure, the term computing device encompasses physical devices that process information. Example types of computing devices include personal computers, laptop computers, mobile telephones, smartphones, tablet computers, in-car computers, television set-top boxes, video conferencing systems, video production equipment, video cameras, video game consoles, or others types of devices that process information.

In some examples, a single computing device may implement two or more of source unit 102, encoding unit 104, decoding unit 106, and presentation unit 108. For example, a single computing device may implement source unit 102 and encoding unit 104. In this example, another computing device may implement decoding unit 106 and presentation unit 108. In other examples, different computing devices implement source unit 102, encoding unit 104, decoding unit 106, and presentation unit 108.

In the example of FIG. 1, a computing device 103 implements encoding unit 104 and a computing device 107 implements decoding unit 106. In some examples, computing device 103 may provide functionality in addition to encoding unit 104. Furthermore, in some examples, computing device 107 may provide functionality in addition to decoding unit 106.

As mentioned briefly above, source unit 102 generates video data that represent a series of frames. A frame is also commonly referred to as a “picture.” When the series of frames in the video data are presented to a user in rapid succession (e.g., 24 or 25 frames per second), the user may perceive objects in the frames to be in motion.

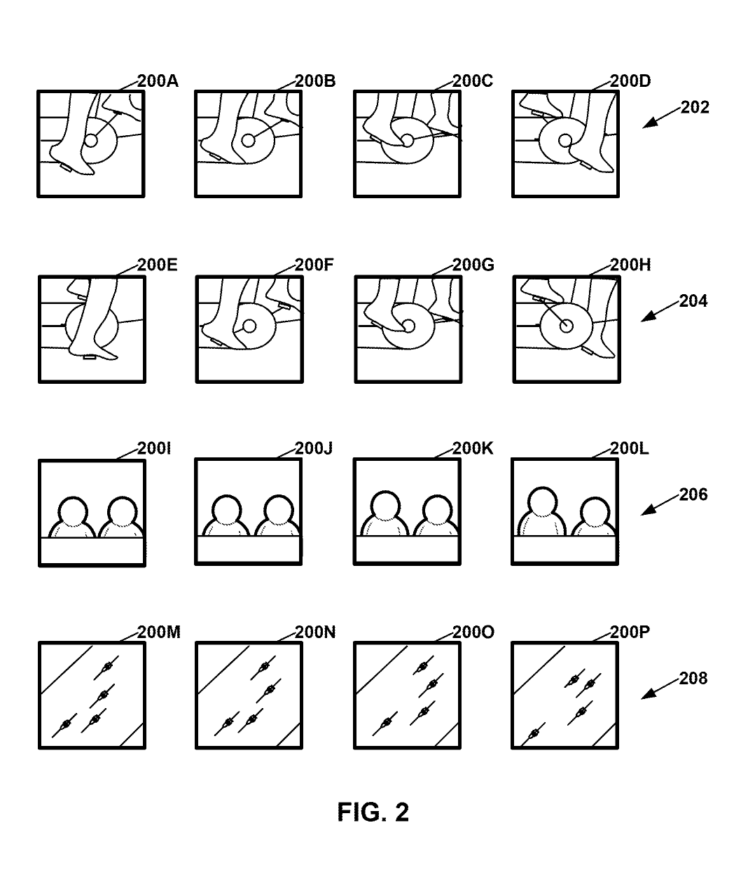

FIG. 2 is a conceptual diagram that illustrates an example series of frames 200A through 200P in video data. This disclosure refers collectively to frames 200A through 200P as “frames 200.” The video data represents scenes of a bicycle race. The frames in rows 202 and 204 show a scene of a person pedaling a bicycle. The frames in row 206 show two commentators sitting behind a desk. The frames in row 208 show a scene of bicycle racers from overhead. Each frame within a scene may differ slightly from the preceding frame. By presenting frames 200 in rapid succession, users may perceive the motion in these scenes.

Continuing reference is now made to the example of FIG. 1. In various examples, source unit 102 generates the video data in various ways. For example, source unit 102 may comprise a video camera. In this example, the video camera captures images from a visible environment. In another example, source unit 102 may comprise one or more sensors for medical, industrial, or scientific imaging. Such sensors may include x-ray detectors, magnetic resonance imaging sensors, particle detectors, and so on. In yet another example, source unit 102 may comprise an animation system. In this example, one or more users use the animation system to draw, draft, program, or otherwise design the content of the video data from their imaginations.

Encoding unit 104 receives the video data generated by source unit 102. Encoding unit 104 encodes the video data such that less data represents the series of frames in the video data. In some instances, encoding the video data in this way may be necessary to ensure that the video data may be stored on a given type of computer-readable media, such as a DVD or CD-ROM. Furthermore, in some instances, encoding the video data in this way may be necessary to ensure that the video data may be efficiently transmitted over a communication network, such as the Internet.

Encoding unit 104 may encode video data, which is often expressed as a sequence or series of video frames. Encoding unit 104 may split these frames into independently decodable portions (which are commonly referred to as “slices”), which in turn, encoding unit 104 may split into treeblocks. These treeblocks may undergo a form of recursive hierarchical quadtree splitting. Encoding unit 104 may perform this splitting to generate a hierarchical tree-like data structure, with the root node being the treeblock. Each undivided sample block within a treeblock corresponds to a different CU. The CU of an undivided sample block may contain information, including motion information and transform information, regarding the undivided sample block.

Encoding unit 104 may use rectangular and/or geometric partitioning modes to partition the sample block of a CU into prediction areas. Each of the prediction areas corresponds to a different PU. For ease of explanation, this disclosure may refer to the prediction area corresponding to a PU as the prediction area of the PU. Encoding unit 104 may then use the prediction areas when performing motion estimation to determine motion information stored as the PU of the CU. When encoding unit 104 uses a geometric partitioning mode to partition the sample block of a CU, a boundary between the partition areas might not meet the edges of the sample block at right angles. Encoding unit 104 may perform a form of motion estimation with respect to each prediction area to generate motion information for each prediction area. A PU of a CU may contain information indicating one or more prediction areas of the CU, the motion information for the prediction area, and/or other information regarding the prediction area. Encoding unit 104 may use the motion information to generate a prediction block.

In accordance with the techniques of this disclosure, encoding unit 104 may implement various techniques for reducing the computational complexity of evaluating prediction blocks generated using various rectangular or geometric partitioning modes. For example, encoding unit 104 may use multiple rectangular partitioning modes to partition the same sample block of a CU into rectangular prediction areas. As used in this disclosure, the term “rectangular PU” may refer to a PU that corresponds to a rectangular prediction area. Encoding unit 104 may then generate motion information for each of the rectangular PUs. Next, encoding unit 104 may use one or more geometric partitioning modes to partition the sample block of the CU into geometric prediction areas. As used in this disclosure, the term “geometric PU” may refer to a PU that corresponds to a geometric prediction area.

Subsequently, encoding unit 104 may identify one of the rectangular PUs as overlapping one of the geometric PUs. A PU may overlap with another PU when the prediction area of one PU includes one or more samples that are in the prediction area of the other PU. Encoding unit 104 may then use the motion information (e.g., a motion vector) for the identified rectangular PU to identify as a starting point for searching a reference frame for a reference sample that corresponds to the geometric PU. As a result, it may be less computationally complex for encoding unit 104 to find the reference sample for the geometric PU. Thus, it may be less computationally complex for encoding unit 104 to generate prediction blocks based on geometric PUs. Consequently, it may be less computationally complex for encoding unit 104 to determine which of the prediction blocks has a least rate and/or distortion cost. A rate cost of a prediction block of a CU indicates a bit rate of encoded data associated with the CU output by encoding unit 104. A distortion cost of a CU indicates an amount of difference between an original version of the sample block of the CU and a decoded version of the sample block of the CU.

Encoding unit 104 then determines residual data for a CU by comparing the original sample block of the CU to the prediction block of the CU. After determining this residual data, encoding unit 104 may transform the residual data. To transform the residual data, encoding unit 104 may partition the residual data into one or more transform areas. Each of the transform areas corresponds to a different transform unit (TU) of the CU. Encoding unit 104 then applies a transformation operation to each of the transform areas. When encoding unit 104 applies the transformation operation to a transform area, encoding unit 104 transforms samples of the residual data that are within the transform area into a block of transform coefficients. This disclosure may refer to a block of transform coefficients as a transform coefficient block.

Each of the transform areas corresponds to a different TU of the CU. The transform area corresponding to a TU may be referred to herein as the transform area of the TU. A TU may store the coefficient block generated by transforming the samples of the residual data that are within the transform area of the TU.

Decoding unit 106 receives the encoded video data. In various examples, decoding unit 106 may receive the encoded video data in various ways. For example, decoding unit 106 may receive a computer-readable medium, such as a DVD, that stores the video data. In another example, decoding unit 106 may receive the encoded video data from a communication medium, such as the Internet, a local area network (LAN), a cable connected to another computing device, or a wireless networking link.

After receiving the encoded video data, decoding unit 106 decodes the encoded video data. When decoding unit 106 decodes the encoded video data, decoding unit 106 converts the encoded video data into a format that presentation unit 108 may use to present the video data to a user. Typically, more data is used to represent the decoded video data than is used to represent the encoded video data.

Presentation unit 108 receives the decoded video data from decoding unit 106. In various examples, presentation unit 108 receives the decoded video data in various ways. For example, where a single computing device provides decoding unit 106 and the presentation system 108, presentation unit 108 may receive the decoded video data via one or more internal communication media, such as cables or buses. In another example, presentation unit 108 may receive the decoded video data from one or more computer-readable media, such as a network connection, DVD, CD-ROM, solid-state memory device, and so on. After receiving the decoded video data, presentation unit 108 presents the frames in the decoded video data to one or more users.

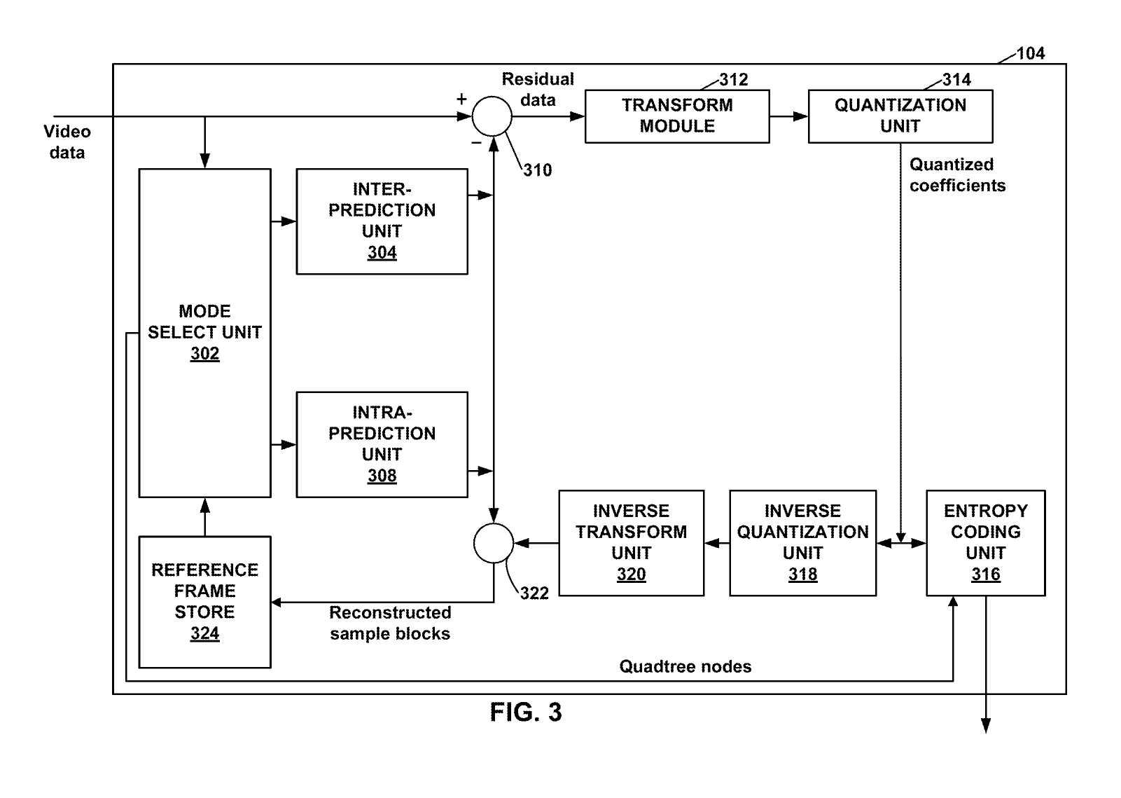

FIG. 3 is a block diagram that illustrates an example configuration of encoding unit 104. In the example of FIG. 3, encoding unit 104 provides a mode select unit 302, an inter-prediction unit 304, an intra-prediction unit 308, a residual generation unit 310, a transform module 312, a quantization unit 314, an entropy coding unit 316, an inverse quantization unit 318, an inverse transform unit 320, a reconstruction unit 322, and a reference frame store 324. Readers will understand that some examples of encoding unit 104 may comprise more, fewer, or different units.

In various examples, encoding unit 104 implements mode select unit 302, inter-prediction unit 304, intra-prediction unit 308, residual generation unit 310, transform module 312, quantization unit 314, entropy coding unit 316, inverse quantization unit 318, inverse transform unit 320, reconstruction unit 322, and reference frame store 324 in various ways. For example, the one or more computing devices that implement encoding unit 104 may implement one or more of these units when processors of the one or more computing devices execute certain computer-readable instructions stored on one or more computer-readable media. In this example, these units or modules may or may not be implemented as discrete, modular pieces of computer software. In another example, the one or more computing devices that implement encoding unit 104 may comprise one or more application-specific integrated circuits (ASICs) that implement the functionality of one or more of these units. In some examples, the functionality of these units may be provided by separate computing devices.

Encoding unit 104 receives data representing frames of video data. When encoding unit 104 receives data representing a frame, encoding unit 104 encodes the frame. For ease of explanation, this disclosure refers to the frame being encoded as the source frame. The data representing the source frame comprises one or more blocks of samples.

To encode the source frame, mode select unit 302 partitions a sample block of the frame among a plurality of treeblocks. In some instances, a treeblock may be an N×N block of luma samples and two corresponding blocks of chroma samples. In some examples, a block is two-dimensional array of samples or transform coefficients. In other instances, a treeblock may be block of luma samples or a chroma sample array.

Mode select unit 302 generates a quadtree for each of the treeblocks. The quadtree for a treeblock comprises a hierarchy of nodes. Initially, the quadtree of the given treeblock only comprises a root node. The root node corresponds to the given treeblock. Mode select unit 302 may partition the given treeblock into multiple smaller sample blocks (i.e., sub-blocks). When mode select unit 302 partitions the given treeblock into sub-blocks, mode select unit 302 adds child nodes to the quadtree of the given treeblock. Each of the child nodes corresponds to a different one of the sub-blocks. In some examples, mode select unit 302 may partition one or more of the sub-blocks into yet smaller sample blocks (i.e., sub-sub-blocks). When mode select unit 302 partitions a sub-block into yet sub-sub-blocks, mode select unit 302 may add grandchild nodes to the quadtree of the given treeblock. Each of the grandchild nodes corresponds to one of the sub-sub-blocks. The grandchild nodes are children of the child nodes. Mode select unit 302 may continue partitioning the given treeblock and generating nodes in the quadtree of the given treeblock as appropriate, up to a pre-configured limit. Unpartitioned sample blocks within the given treeblock correspond to leaf nodes of the quadtree. The leaf nodes of the quadtree may be referred to herein as coding nodes.

Each of the coding nodes corresponds to a different CU. A coding node of a CU is a root node of a prediction tree and a transform tree. The prediction tree stores information of PUs of the CU. For example, the prediction tree may specify sizes and positions of prediction areas of the PUs. The PUs of the CU may also comprise additional associated prediction data. The transform tree stores information regarding TUs of the CU. For example, the transform tree may explicitly or implicitly indicate sizes and positions of transform areas of the TUs. The TUs of the CU may also comprise additional associated transform data.

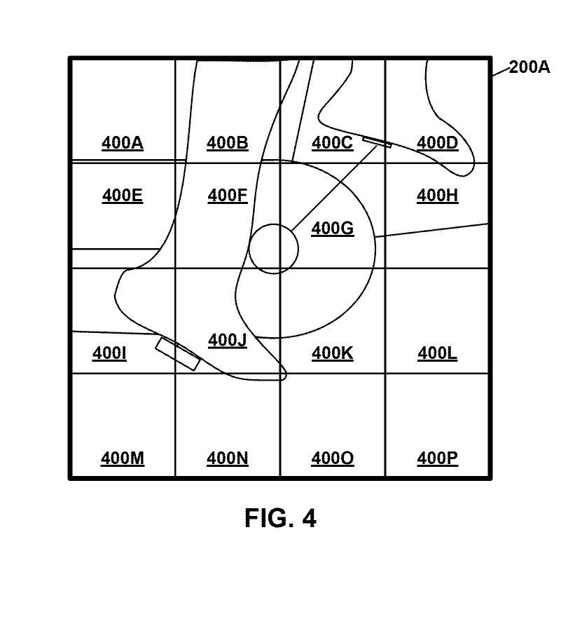

FIG. 4 is a conceptual diagram that illustrates example frame 200A partitioned into treeblocks 400A through 400P (collectively, “treeblocks 400”). Each of treeblocks 400 is square and has the same size. For example, the sample blocks of treeblocks 400 may be 32 samples wide by 32 samples high (i.e., 32×32). In another example, the sample blocks of treeblocks 400 may be 64 samples wide by 64 samples high (i.e., 64×64).

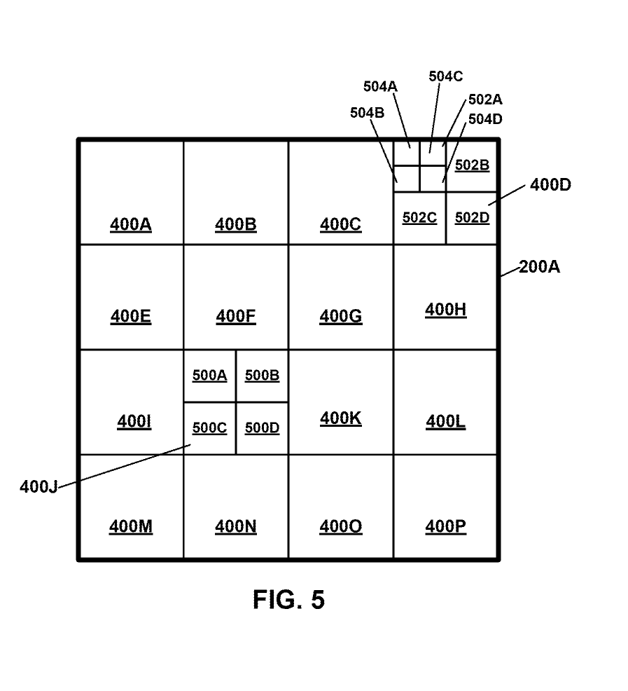

FIG. 5 is a conceptual diagram that illustrates a further example partitioning of treeblocks 400. In the example of FIG. 5, mode select unit 302 has partitioned the sample block of treeblock 400J into four smaller sample blocks 500A through 500D. Furthermore, in the example of FIG. 5, mode select unit 302 has partitioned sample block 400D into four sample blocks 502A through 504D. Mode select unit 302 has further subdivided sample block 502A into four more sample blocks 504A through 504D.

Continuing reference is now made to the example of FIG. 3. After mode select unit 302 generates a quadtree for a treeblock, inter-prediction unit 304 performs an inter-frame coding operation for each CU of the treeblock. When inter-prediction unit 304 performs the inter-frame coding operation for a CU, inter-prediction unit 304 uses rectangular and/or geometric partitioning modes to generate one or more PUs for the CU. The sample block of the CU is partitioned between the PUs of the CU. In other words, the sample block of the CU is partitioned among the prediction areas of the PUs of the CU.

After inter-prediction unit 304 uses a given partitioning mode to generate the PUs of a CU, inter-prediction unit 304 may perform motion estimation operations for each of the PUs. When inter-prediction unit 304 performs a motion estimation operation for a PU, inter-prediction unit 304 searches a reference frame for a reference sample for the PU. A reference sample for a PU is a portion of a reference frame that corresponds to the samples within the prediction area of the PU. Inter-prediction unit 304 generates motion information for the PU to indicate the reference sample for the PU.

Inter-prediction unit 304 uses the reference samples for the PUs of a CU to generate a trial prediction block for the CU. The trial prediction block of a CU is a block of predicted samples. The trial prediction block for a CU may differ somewhat from the sample block of the CU. For example, samples in the trial prediction block may have slightly different color or brightness values from the corresponding samples of the sample block of the CU.

Intra-prediction unit 308 may use samples in the sample blocks of other CUs of the source frame to generate a prediction block for the CU. In various examples, intra-prediction unit 308 generates the prediction block in various ways. For example, intra-prediction unit 308 may generate the prediction block of the CU such that samples in neighboring CUs extend horizontally across or vertically down through the prediction block. Intra-prediction unit 308 may also select an intra-prediction mode that best corresponds to the sample block of the CU.

After inter-prediction unit 306 and intra-prediction unit 308 generate trial prediction blocks for the CU, mode select unit 302 may select one of the trial prediction blocks to be the prediction block for the CU. To select one of the trial prediction blocks, mode select unit 302 may compare the trial prediction blocks to the original sample block of the CU in order to evaluate rate and/or distortion cost of the trial prediction blocks. Generating trial prediction blocks based on each rectangular and geometric prediction mode and evaluating rate and/or distortion costs of these trial prediction blocks may be computationally intensive. According to the techniques of this disclosure, inter-prediction unit 304 may be configured to perform operations that reduce the computational intensity of selecting one of the trial prediction blocks to be the prediction block for the CU. For example, inter-prediction unit 304 may be configured to use motion vectors of rectangular PUs to guide searches for reference samples corresponding to geometric PUs, thus potentially reducing the computational intensity associated with searching for the references samples corresponding to the geometric PUs.

If the mode select unit 302 selects a prediction block generated by intra-prediction unit 308, mode select unit 302 may add a syntax element to the coding node of the CU to indicate the intra-prediction mode that intra-prediction unit 308 used when generating the selected prediction block. If mode select unit 302 selects a prediction block generated by inter-prediction unit 304, mode select unit 302 may add a syntax element to the coding node for the CU that indicates that inter-prediction was used to encode the CU. In addition, mode select unit 302 may add syntax elements to the prediction tree of the CU. For example, mode select unit 302 may add syntax elements to the prediction tree indicating the sizes and locations of PUs of the CU, motion vectors for the PUs, and other data generated during the inter-frame coding operation. Furthermore, mode select unit 302 may add syntax elements to the transform tree of the CU. For example, mode select unit 302 may add syntax elements to the transform tree indicating the sizes and locations of TUs of the CU.

In some examples, a syntax element is an element of data represented in a bitstream. A bitstream may be a sequence of bits that forms a representation of coded pictures and associated data forming one or more coded video sequences. A coded video sequence may be a sequence of access units. An access unit may be a set of NAL units that are consecutive in decoding order and contain exactly one primary coded picture. A NAL unit may be a syntax structure containing an indication of the type of data to follow and bytes containing that data in the form of a raw byte sequence payload interspersed as necessary with emulation prevention bits. A primary coded picture may be a coded representation of a picture to be used by a decoding process for a bitstream.

After mode select unit 302 selects a prediction block of the CU, residual generation unit 310 may use the sample block of the CU and the selected prediction block of the CU to generate residual data for the CU. In some examples, the residual data for the CU may be arranged as a two-dimensional array of the residual data (i.e., a residual block). The residual data for the CU may represent the differences between the sample block of the CU and the prediction block of the CU. In various examples, residual generation unit 310 may generate the residual data in various ways. For example, residual generation unit 310 may generate the residual data for the CU by subtracting the samples in the original prediction block of the CU from the samples in the sample block of the CU.

When residual generation unit 310 generates residual data for the CU, transform module 312 may perform a transform operation for each TU of the CU. When transform module 312 performs the transform operation for a TU of the CU, transform module 312 transforms samples of the residual data in the transform area specified by the TU to generate a transform block. The transform block is a two-dimensional array of transform coefficients. In some examples, a transform coefficient may be a scalar quantity, considered to be in a frequency domain, that is associated with a particular one-dimensional or two-dimensional frequency index in an inverse transform part of a decoding process.

When transform module 312 performs the transform operation on a TU, transform module 312 applies a mathematical transformation to the transform block. For example, transform module 312 may perform a Discrete Cosine Transform (DCT) on the transform block to transform the video data from the spatial domain to the frequency domain.

Transform module 312 may provide the resulting transform block to quantization unit 314. Quantization unit 314 may perform a quantization operation on the transform block. When quantization unit 314 performs the quantization operation, quantization unit 314 may quantize each of the transform coefficients in the transform block, thereby generating a quantized transform block. The quantized transform block is a two-dimensional array of quantized transform coefficients. In various examples, quantization unit 314 performs various quantization operations. For example, quantization unit 314 may perform a quantization operation that quantizes the transform coefficients by dividing the transform coefficients by a quantization parameter and then clipping the resulting quotients.

After quantization unit 314 performs the quantization operation on the transform blocks of the CU, entropy coding unit 316 performs an entropy coding operation on the quantized transform block of the CU, the coding node of the CU, the prediction tree of the CU, and the transform tree of the CU. Entropy coding unit 316 generates entropy coded data for the CU as a result of performing this entropy coding operation. In some instances, when entropy coding unit 316 performs the entropy coding operation, quantization unit 314 may reduce the number of bits needed to represent the data of the CU. In various instances, entropy coding unit 316 may perform various entropy coding operations on the data of the CU. For example, entropy coding unit 316 may perform a context-adaptive variable-length coding (CAVLC) operation or a context-adaptive binary arithmetic coding (CABAC) operation on the data of the CU.

Encoding unit 104 generates a bitstream that includes entropy encoded data for the CU. In various examples, encoding unit 104 may generate various types of bitstreams that include the entropy encoded data for the CU. For example, encoding unit 104 may output a network abstraction layer (NAL) unit stream. In this example, the NAL unit stream comprises a sequence of syntax structures called NAL units. The NAL units are ordered in decoding order. The one or more of the NAL units may include the entropy encoded data for the CU. In another example, encoding unit 104 may output a byte stream. Encoding unit 104 constructs the byte stream from a NAL unit stream by ordering NAL units in decoding order and prefixing each NAL unit with a start code prefix and zero or more zero-value bytes to form a stream of bytes.

Inverse quantization unit 318 performs an inverse quantization operation on quantized transform blocks. The inverse quantization operation at least partially reverses the effect of the quantization operation performed by quantization unit 314, thereby generating transform blocks.

Inverse transform unit 320 performs an inverse transform operation on transform blocks generated by inverse quantization unit 318. When inverse transform unit 320 performs the inverse transform operation, inverse transform unit 320 reverses the effect of the transformation operation performed by transform module 312, thereby generating reconstructed residual data.

Reconstruction unit 322 performs a reconstruction operation that generates reconstructed sample blocks. Reconstruction unit 322 generates the reconstructed sample blocks based on the reconstructed residual data and the prediction blocks generated by inter-prediction unit 304 or intra-prediction unit 308. In various examples, reconstruction unit 322 performs various reconstruction operations. For example, reconstruction unit 322 performs the reconstruction operation by adding the samples in the reconstructed residual data with corresponding samples in the prediction blocks.

Reference frame store 324 stores the reconstructed sample blocks. After encoding unit 104 has encoded data for each CU of the source frame, encoding unit 104 has generated reconstructed sample blocks for each CU in the source frame. Hence, reference frame store 324 stores a complete reconstruction of the source frame. Mode select unit 302 may provide the reconstructions of the source frame to inter-prediction unit 304 as a reference frame.

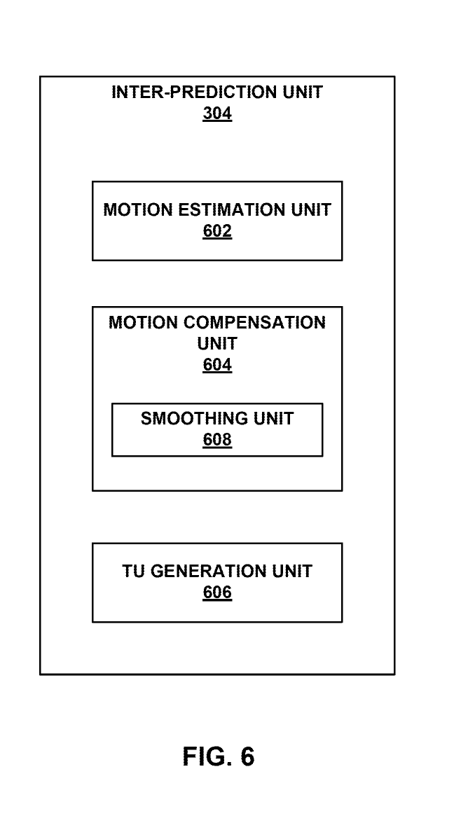

FIG. 6 is a block diagram that illustrates an example configuration of inter-prediction unit 304. In the example of FIG. 6, inter-prediction unit 304 comprises a motion estimation unit 602, a motion compensation unit 604, and a TU generation unit 606. Motion compensation unit 604 comprises a smoothing unit 608. Readers will understand that other example configurations of inter-prediction unit 304 may include more, fewer, or different components.

As described in detail elsewhere in this disclosure, motion estimation unit 602 may generate one or more PUs for a CU and perform a motion estimation operation for each of the PUs. Motion compensation unit 604 may perform a motion compensation operation that generates a prediction block for the CU. TU generation unit 606 may perform a transform unit selection operation that generates transform units (TUs) of the CU. Smoothing unit 608 may perform a transition smoothing operation in which samples in transition zones of the prediction block are smoothed.

To generate the PUs for a CU, motion estimation unit 602 may use rectangular and/or geometric partitioning modes to partition the sample block of the CU into prediction areas. Motion estimation unit 602 may then generate one or more prediction trees. Each of the prediction trees may be associated with a different PU of the CU. Each of the prediction trees may specify a position and a size of one of the prediction areas. For ease of explanation, this disclosure can refer to the position or size of the prediction area specified by the prediction tree of a PU as the position or size of the PU.

Motion estimation unit 602 may search one or more reference frames for reference samples corresponding to the PUs. The reference samples of a PU may be areas of the reference frames that visually correspond to portions of the sample block of the CU that fall within the prediction area of the PU. If motion estimation unit 602 finds such a reference sample for one of the PUs, motion estimation unit 602 may generate a motion vector. The motion vector includes a set of data that describes a difference between the spatial position of the reference sample for a PU and the spatial position of the PU. For example, the motion vector may indicate that the reference sample of a PU is five samples higher and three samples to the right of the PU. Furthermore, in some circumstances, motion estimation unit 602 may not be able to identify a reference sample for a PU. In such circumstances, motion estimation unit 602 may select a skip mode or a direct mode for the PU. In some examples, the position of the PU is a position of the prediction area indicated by the prediction tree of the PU.

In accordance with the techniques of this disclosure, when motion estimation unit 602 performs a motion estimation operation on a geometric PU, motion estimation unit 602 may identify a rectangular PU that overlaps the geometric PU. Motion estimation unit 602 may then use the motion estimation information for the rectangular PU to identify a given area of a reference frame. Motion estimation unit 602 may then use the given area of the reference frame as a starting point for searching the reference frame for a reference sample. This reference sample is an area of the reference frame that corresponds to the geometric PU. Motion estimation unit 602 may then generate a motion vector for the geometric PU. The motion vector for the geometric PU indicates a position of the reference sample relative to a position of the geometric PU.

In some examples, rather than performing a search for a reference sample of a PU, motion estimation unit 602 may predict a motion vector for the PU. In performing this motion vector prediction, motion estimation unit 602 may select one of the motion vectors determined for spatially neighboring CUs in the source frame or a motion vector determined for a co-located CU in a reference frame. Motion estimation unit 602 may perform motion vector prediction rather than search for a reference sample in order to reduce complexity associated with determining a motion vector for each partition.

Motion compensation unit 604 uses the inter-coding modes of the PUs to generate the prediction block of the CU. If motion estimation unit 602 selected the skip mode for a PU, motion compensation unit 604 may generate the prediction block of the CU such that samples in the prediction block that are associated with the PU match collocated samples in the reference frame. If motion estimation unit 602 selected the direct mode for a PU, motion compensation unit 604 may generate the prediction block such that samples in the prediction block that are associated with the PU match collocated samples in the sample block of the CU. If motion estimation unit 602 generated a motion vector for a PU, motion compensation unit 604 may generate the prediction block such that samples in the prediction block that are associated with the PU correspond to samples in a portion of the reference frame indicated by the motion vector.

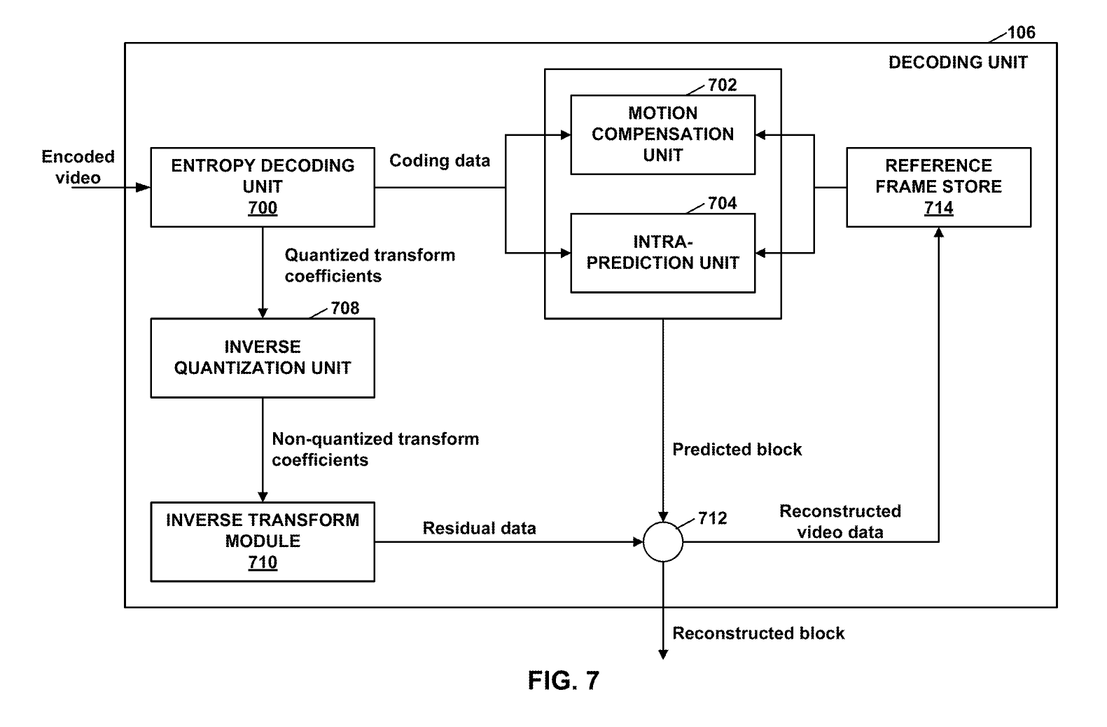

FIG. 7 is a block diagram that illustrates an example configuration of decoding unit 106. As illustrated in the example of FIG. 7, decoding unit 106 implements an entropy decoding unit 700, a motion compensation unit 702, an intra-prediction unit 704, an inverse quantization unit 708, an inverse transform module 710, a reconstruction unit 712, and a reference frame store 714. In various examples, decoding unit 106 implements these components in various ways. For example, the one or more computing devices that provide decoding unit 106 may implement these units when processors of the computing devices execute certain computer-readable instructions. In this example, these units or modules may or may not be implemented as discrete, modular pieces of computer software. In another example, the one or more computing devices that implement decoding unit 106 may comprise ASICs that provide the functionality of one or more of these units.

Decoding unit 106 receives an encoded bitstream that represents video data. The encoded bitstream may comprise data representing frames in the video data. For example, the encoded bitstream may comprise data representing each of frames 200 (FIG. 2). When decoding unit 106 receives data representing for a frame, decoding unit 106 decodes the data to reconstruct the frame. For ease of explanation, this disclosure may refer to this frame as the source frame.

When decoding unit 106 decodes the data for the source frame, decoding unit 106 receives encoded data for each CU of the source frame. For example, decoding unit 106 can receive an encoded version of a quantized transform block for the CU, an encoded version of the coding node of the CU, an encoded version of the prediction tree of the CU, and an encoded version of the transform tree of the CU. Decoding unit 106 then decodes the data of each CU of the source frame. When decoding the data of a given CU, entropy decoding unit 700 receives encoded data for the given CU. Entropy decoding unit 700 performs an entropy decoding operation on the encoded data for the given CU. The entropy decoding operation reverses the effects of the entropy coding operation performed by entropy coding unit 316 (FIG. 3).

Entropy decoding unit 700 provides the quantized transform block for the CU to inverse quantization unit 708. Entropy decoding unit 700 may provide coding data for the CU, such as the coding node, prediction tree, and transform tree of the CU, to motion compensation unit 702 and/or intra-prediction unit 704.

When motion compensation unit 702 receives the coding data for the CU, motion compensation unit 702 uses the coding data to perform a motion compensation operation that generates a prediction block for the CU. During the motion compensation operation, motion compensation unit 702 may retrieve one or more reference frames from reference frame store 714. The motion compensation unit 702 may then identify reference samples for PUs of the CU. The motion vectors for the PUs identify areas within the references frames as the reference samples for the PUs. After identifying the reference samples for PUs of the CU, motion compensation unit 702 generates a prediction block for the CU. In the prediction block, PUs of the CU may contain the reference samples of the PUs.

When intra-prediction unit 704 receives the coding data for the CU, intra-prediction unit 704 uses the reconstructed sample blocks of previously decoded CU in the source frame to generate the prediction block for the CU. Intra-prediction unit 704 may modify the samples in the prediction block according to an indicated intra-prediction mode.

Inverse quantization unit 708 receives one or more quantized transform coefficient blocks for each CU. When inverse quantization unit 708 receives a quantized transform coefficient block for a CU, inverse quantization unit 708 performs an inverse quantization operation that at least partially reverses the effect of the quantization operation performed by quantization unit 314 (FIG. 3), thereby generating non-quantized transform coefficient block for the CU.

Inverse transform module 710 performs an inverse transform operation on transform coefficient blocks. The inverse transform operation may reverse the effect of the transformation operation performed by transform module 312 (FIG. 3), thereby generating reconstructed residual data. Inverse transform module 710 provides the reconstructed residual data to reconstruction unit 712.

Reconstruction unit 712 receives the prediction blocks from motion compensation unit 702 and intra-prediction unit 704. Reconstruction unit 712 also receives corresponding reconstructed residual data from inverse transform module 710. Reconstruction unit 712 performs a reconstruction operation that uses reconstructed residual data of a CU and a prediction block for the CU to generate a reconstructed sample block for the CU. In various examples, reconstruction unit 712 may perform various reconstruction operations. For example, reconstruction unit 712 may generate the reconstructed sample block of the CU by adding the samples in the reconstructed residual data of the CU with corresponding samples in the prediction block of the CU.

After generating a reconstructed sample block for a CU, reconstruction unit 712 outputs the reconstructed sample block. Reconstruction unit 712 also provides the reconstructed sample block to reference frame store 714. Reference frame store 714 stores the reconstructed sample block. Motion compensation unit 702 and/or intra-prediction unit 704 may subsequently use the reconstructed sample block to generate additional prediction blocks.

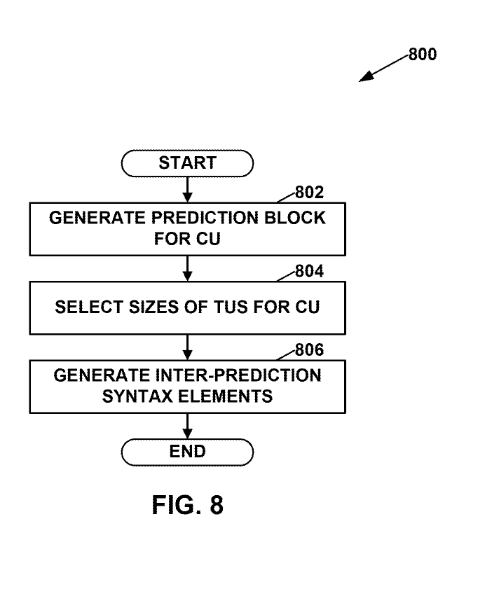

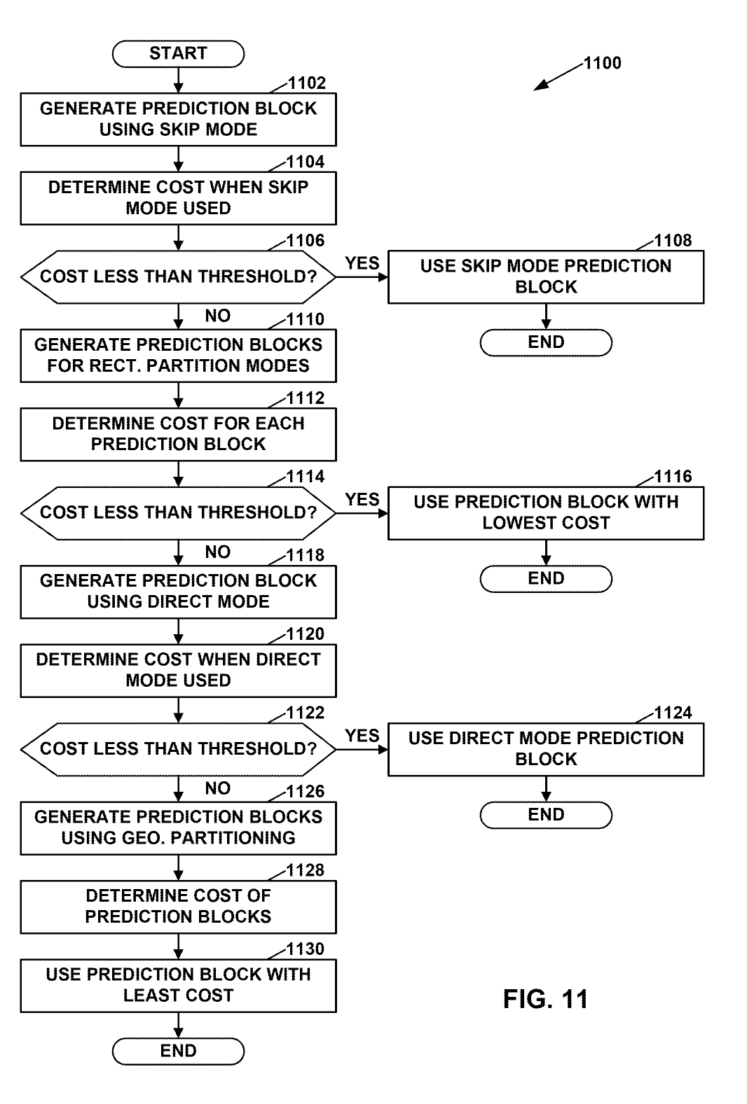

FIG. 8 is a flowchart that illustrates an example inter-frame coding operation 800 performed by inter-prediction unit 304. After encoding unit 104 starts inter-frame coding operation 800, inter-prediction unit 304 generates a prediction block for a CU (802). In some examples, inter-prediction unit 304 may generate multiple trial prediction blocks for the CU. Mode select unit 302 may then select one of the trial prediction blocks to be the prediction block for the CU. As described with regard to FIGS. 11, 12, 13A, 13B, 14, and 15, inter-prediction unit 304 can, in accordance with the techniques of this disclosure, generate the trial prediction blocks and select trial prediction blocks in various ways.

In addition, TU generation unit 606 may perform a transform selection operation to select sizes of TUs for the CU (804). As discussed above, transform module 312 may receive residual data for the CU. Transform module 312 may then perform a transform operation on each TU of the CU. When transform module 312 performs the transform operation on a TU, transform module 312 may apply a transform to samples of the residual data that correspond to the TU, thereby generating a transform coefficient block for the TU. Samples of the residual data may correspond to a TU when the samples are within the transform area specified by the transform tree of the TU. Inverse transform unit 320 in encoding unit 104 and inverse transform module 710 in decoding unit 106 also use transforms having the selected transform sizes when transforming transform coefficient blocks into sample blocks.

Furthermore, inter-prediction unit 304 may generate inter-prediction syntax elements (806). The inter-prediction syntax elements may provide information about the CU and the prediction block. For example, the inter-prediction syntax elements may include syntax elements that indicate whether the CU has more than one PU. In this example, if the CU has more than one PU, the inter-prediction syntax elements may also indicate sizes, shapes, and/or locations of the prediction areas of the PUs. In another example, the inter-prediction syntax elements may specify inter-prediction modes for the PUs of the CU. Furthermore, the inter-prediction syntax elements may include data based on motion vectors for one or more of the PUs of the CU. In another example, the inter-prediction syntax elements may indicate sizes and/or location of TUs of the CU. In some examples, the set of inter-prediction syntax elements includes some or all of the inter-prediction syntax elements specified by the H.264 MPEG Part 10 standard or the emerging High Efficiency Video Coding (HEVC) standard.

If mode select unit 302 selects the prediction block generated in step 802, inter-prediction unit 304 may output the prediction block to residual generation unit 310 and reconstruction unit 322. Furthermore, if mode select unit 302 selects the prediction block generated in step 802, mode select unit 302 may include the intra-prediction syntax elements in the coding node, prediction tree, and/or transform tree of the CU.

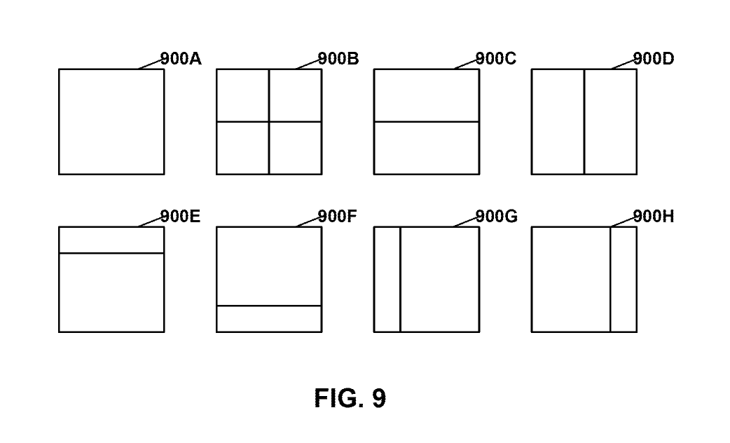

FIG. 9 is a conceptual diagram that illustrates example rectangular partitioning modes. As explained briefly above, motion estimation unit 602 may generate one or more PUs for a CU. Each of the PUs may have prediction tree that specifies a size and a position of a prediction area. Each of the prediction areas may correspond to a different partition of the sample block of the CU. For ease of explanation, this disclosure may explain that a PU corresponds to a partition of the sample block of a CU when the prediction area specified by the prediction tree of the PU corresponds to the partition of the sample block of the CU.

In various examples, motion estimation unit 602 may use various partitioning modes to generate the PUs of the CU. Such partitioning modes may include rectangular partitioning modes. In rectangular partitioning modes, the PUs correspond to rectangular-shaped partitions of the sample block of the CU. In some examples, motion estimation unit 602 is able to use some or all rectangular partitioning modes defined in the H.264 MPEG Part 10 standard.

The example of FIG. 9 illustrates rectangular partitioning modes 900A-H (collectively, “rectangular partitioning modes 900”). In rectangular partitioning mode 900A, motion estimation unit 602 generates a single PU for the CU. The prediction area of this PU is the same size as the sample block of the CU. In rectangular partitioning mode 900B, motion estimation unit 602 generates four PUs for the CU. The PUs generated using rectangular partitioning mode 900B correspond to four equally-sized partitions of the sample block of the CU.

In rectangular partitioning modes 900C through 900H, motion estimation unit 602 generates two PUs for the CU. The PUs generated using rectangular partitioning mode 900C correspond to equally-sized, horizontally-divided partitions of the sample block of the CU. The PUs generated using rectangular partitioning mode 900D correspond to equally-sized, vertically-divided partitions of the sample block of the CU.

The PUs generated using rectangular partitioning mode 900E correspond to horizontally-divided partitions of the sample block in which the lower partition is larger than the upper partition. In some examples, motion estimation unit 602 may partition the sample block horizontally at any sample in the sample block above a horizontal midline of the sample block. The PUs generated using rectangular partitioning mode 900F correspond to horizontally-divided partitions of the sample block in which the lower partition is smaller than the upper partition. In some examples, motion estimation unit 602 may partition the sample block horizontally at any sample in the sample block below a horizontal midline of the sample block.

The PUs generated using rectangular partitioning mode 900G correspond to vertically-divided partitions of the sample block in which the left partition is smaller than the right partition. In some examples, motion estimation unit 602 may partition the sample block vertically at any sample in the sample block to the left of a vertical midline of the sample block. The PUs generated using rectangular partitioning mode 900H correspond to vertically-divided partitions of the sample block in which the left partition is larger than the right partition. In some examples, motion estimation unit 602 may partition the sample block vertically at any sample in the sample block to the right of a vertical midline of the sample block.

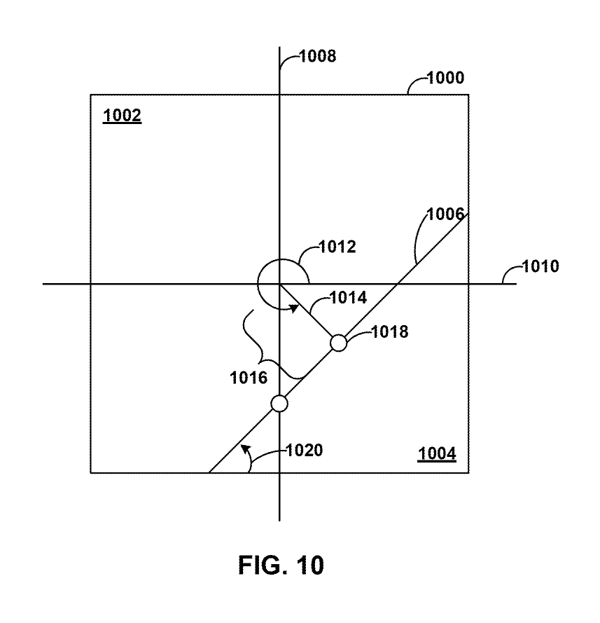

FIG. 10 is a conceptual diagram that illustrates example geometric partitioning modes. In some examples, motion estimation unit 602 uses a geometric partitioning mode to generate two PUs for a CU. When motion estimation unit 602 uses a geometric partitioning mode to generate the PUs for the CU, the PUs correspond to partitions of the sample block of the CU whose boundaries do not necessarily meet the edges of the sample block at right angles.

In the example of FIG. 10, motion estimation unit 602 has used a geometric partitioning mode to partition a sample block 1000 into a first partition 1002 and a second partition 1004. A partitioning line 1006 separates first partition 1002 and second partition 1004. For ease of explanation, FIG. 10 illustrates a vertical midline 1008 and a horizontal midline 1010 of sample block 1000. Two parameters define the geometric partitioning mode used to partition sample block 1000. In this disclosure, these two parameters are referred to as theta and rho. The theta parameter indicates an angle 1012 at which a line 1014 extends from a central point of sample block 1000. The rho parameter indicates a length 1016 of line 1014. Thus, the theta and rho parameters act as polar coordinates to indicate a point 1018 within sample block 1000. Partitioning line 1006 is defined such that partitioning line 1006 meets line 1014 at a right angle. In the example of FIG. 10, an angle 1020 at which partitioning line 1006 meets an edge of sample block 1000 is not a right angle. In this way, the theta and rho parameters define the location of partitioning line 1006. By using various values for the theta and rho parameters, motion estimation unit 602 may define various lines that partition sample block 1000.

Partitioning line 1006 and line 1014 are not necessarily visually present in sample block 1000 and are shown in FIG. 10 to illustrate how sample block 1000 may be geometrically partitioned.

FIG. 11 is a flowchart that illustrates an example operation 1100 performed by inter-prediction unit 304 to generate a prediction block for a CU. Because there may be many possible combinations of theta and rho values, there may be many different geometric partitioning modes. It may be computationally complex to determine which of the many geometric partitioning modes produces a prediction block with a lowest rate and/or distortion cost. Such computational complexity may slow the process of encoding multimedia data. Operation 1100 implements an example technique that may reduce the computational complexity of encoding video data by only evaluating geometric partitioning modes if other inter-frame coding modes and rectangular partitioning modes produce prediction blocks with levels of distortion that exceed various thresholds.

After inter-prediction unit 304 begins operation 1100, inter-prediction unit 304 generates a trial prediction block using skip mode encoding (1102). In other words, inter-prediction unit 304 generates the trial prediction block such that the trial prediction block has the same content as the spatially corresponding area in a reference frame. For ease of explanation, this disclosure refers to this trial prediction block as the skip-mode prediction block. After generating the skip-mode prediction block, inter-prediction unit 304 determines a rate and/or distortion cost of the skip-mode prediction block (1104). The distortion cost of the skip-mode prediction block is correlated with a degree to which the skip-mode prediction block differs from the sample block of the CU.

Inter-prediction unit 304 then determines whether the rate and/or distortion cost of the skip-mode prediction block is less than a given threshold (1106). In various examples, inter-prediction unit 304 determines whether the rate and/or distortion cost of the skip-mode prediction block is less than various thresholds. For example, inter-prediction unit 304 may use a threshold based on various factors, such as block size and quantization parameters. If the rate and/or distortion cost of the skip-mode prediction block is less than the given threshold (“YES” of 1106), inter-prediction unit 304 uses the skip-mode prediction block generated using the skip mode as the prediction block for the CU (1108). Inter-prediction unit 304 then ends operation 1100.

On the other hand, if the rate and/or distortion cost of the skip-mode prediction block is not less than the given threshold (“NO” of 1106), inter-prediction unit 304 may generate trial prediction blocks for rectangular partitioning modes (1110). For example, inter-prediction unit 304 may use rectangular partitioning modes to one or more generate PUs corresponding to rectangular partitions of the sample block of the CU, perform motion estimation operations for PUs, and perform motion compensation operations to generate prediction blocks based on the motion vectors identified during the motion estimation operations. For ease of explanation, this disclosure refers to the trial prediction blocks for the rectangular partitioning modes as the rectangular-partitioned prediction blocks.

After generating the rectangular-partitioned prediction blocks, inter-prediction unit 304 determines a rate and/or distortion cost of each of the rectangular-partitioned prediction blocks (1112). Inter-prediction unit 304 then determines whether the rate and/or distortion cost of any of the rectangular-partitioned prediction blocks is less than a given threshold (1114). In various examples, inter-prediction unit 304 determines whether the rate and/or distortion costs of the rectangular-partitioned prediction blocks are less than various thresholds. For example, inter-prediction unit 304 may use a threshold based on a block size or a quantization parameter. In some examples, this threshold is the same or different than the threshold used in step 1106. If any of the rectangular-partitioned prediction blocks has a rate and/or distortion cost less than the given threshold (“YES” of 1114), inter-prediction unit 304 uses the rectangular-partitioned prediction block having the lowest rate and/or distortion cost as the prediction block for the CU (1116). Inter-prediction unit 304 then ends operation 1100.

If none of the rectangular-partitioned prediction blocks has a rate and/or distortion cost less than the given threshold (“NO” of 1114), inter-prediction unit 304 may generate a trial prediction block using direct mode encoding (1118). For ease of explanation, this disclosure refers to the trial prediction block generated using direct mode encoding as the direct-coded prediction block. After generating the direct-coded CU, inter-prediction unit 304 determines a rate and/or distortion cost of the direct-coded prediction block (1120).

Inter-prediction unit 304 then determines whether the rate and/or distortion cost of the direct-coded prediction block is less than a given threshold (1122). In various examples, inter-prediction unit 304 determines whether the rate and/or distortion cost of the direct-coded prediction block is less than various thresholds. For example, inter-prediction unit 304 may use a threshold that depends one or more factors, such as block size and quantization parameter. In some examples, this threshold is the same or different than the threshold used in step 1106 and/or step 1114. If the direct-coded prediction block has a rate and/or distortion cost less than the given threshold (“YES” of 1122), inter-prediction unit 304 uses the direct-coded prediction block as the prediction block for the CU (1124). Inter-prediction unit 304 then ends operation 1100.

However, if the rate and/or distortion cost of the direct-coded prediction block is not less than the given threshold (“NO” of 1122), inter-prediction unit 304 may generate trial prediction blocks for geometric partitioning modes (1126). For instance, inter-prediction unit 304 may generate a trial prediction block for each allowable combination of theta and rho parameters. For ease of explanation, this disclosure refers to the trial prediction blocks for the geometric partitioning modes as geometric-partitioned prediction blocks.

After generating the geometric-partitioned prediction blocks, inter-prediction unit 304 determines rate and/or distortion cost of each of the geometric-partitioned prediction blocks (1128). Inter-prediction unit 304 may then use whichever one of the skip-mode prediction block, rectangular-coded prediction blocks, direct-coded prediction block, or geometric-partitioned prediction blocks has a least rate and/or distortion cost as the prediction block for the CU (1130). Inter-prediction unit 304 then ends operation 1100.

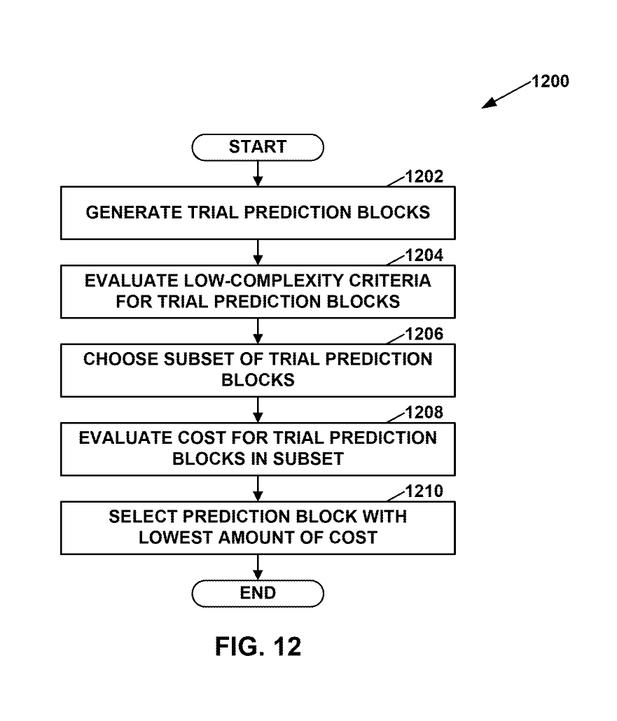

FIG. 12 is a flowchart that illustrates another example operation 1200 performed by inter-prediction unit 304 to generate a prediction block for a CU. Inter-prediction unit 304 may perform operation 1200 as an alternate to operation 1100. As mentioned above, it may be computationally complex to determine which of the many geometric partitioning modes produces a prediction block with a lowest rate and/or distortion cost. While operation 1100 attempts to reduce the computational complexity of encoding multimedia data by only evaluating geometric partitioning modes if other inter-coding modes are initially deemed insufficient, operation 1200 may attempt to reduce the computational complexity by potentially reducing the number of times inter-prediction unit 304 evaluates the rate and/or distortion cost of trial prediction blocks.

After inter-prediction unit 304 starts operation 1200, inter-prediction unit 304 uses rectangular and geometric partitioning to generate trial prediction blocks (1202). For example, inter-prediction unit 304 may generate trial prediction blocks using each of rectangular partitioning modes 900 and each allowable combination of theta and rho parameters.

After generating the trial prediction blocks, inter-prediction unit 304 evaluates low-complexity criteria for the trial prediction blocks (1204). Evaluating low-complexity criteria may generally approximate a result of performing a rate-distortion analysis on a trial prediction block, but may be less computationally expensive than performing the rate-distortion analysis. Example low-complexity criteria may include, but are not limited to, prediction error from zero motion vector, prediction error from predicted motion vector, prediction error from motion vector of a motion search, and so on.

After evaluating the low-complexity criteria for the trial prediction blocks, inter-prediction unit 304 chooses a subset of the trial prediction blocks (1206). Inter-prediction unit 304 chooses the subset such that the trial prediction blocks in the subset have low-complexity criteria associated with lower rate and/or distortion cost than the trial prediction blocks not in the subset. In various examples, the subset may include various numbers of trial prediction blocks. For example, the subset may include ten or fewer trial prediction blocks. In another example, the subset may only include five trial prediction blocks.

After choosing the subset, inter-prediction unit 304 evaluates rate and/or distortion cost for each of the trial prediction blocks in the subset (1208). Inter-prediction unit 304 then selects the trial prediction block in the subset having the lowest rate and/or distortion cost as the prediction block for the CU (1210). In this way, inter-prediction unit 304 may be able to identify a trial prediction block with a sufficiently low rate and/or distortion cost without evaluating the rate and/or distortion costs of each of the trial prediction blocks. Because inter-prediction unit 304 may not evaluate the rate and/or distortion cost in prediction blocks generated using each geometric partitioning mode, the computational complexity of identifying a prediction block for the CU may be reduced. Subsequently, inter-prediction unit 304 ends operation 1200.

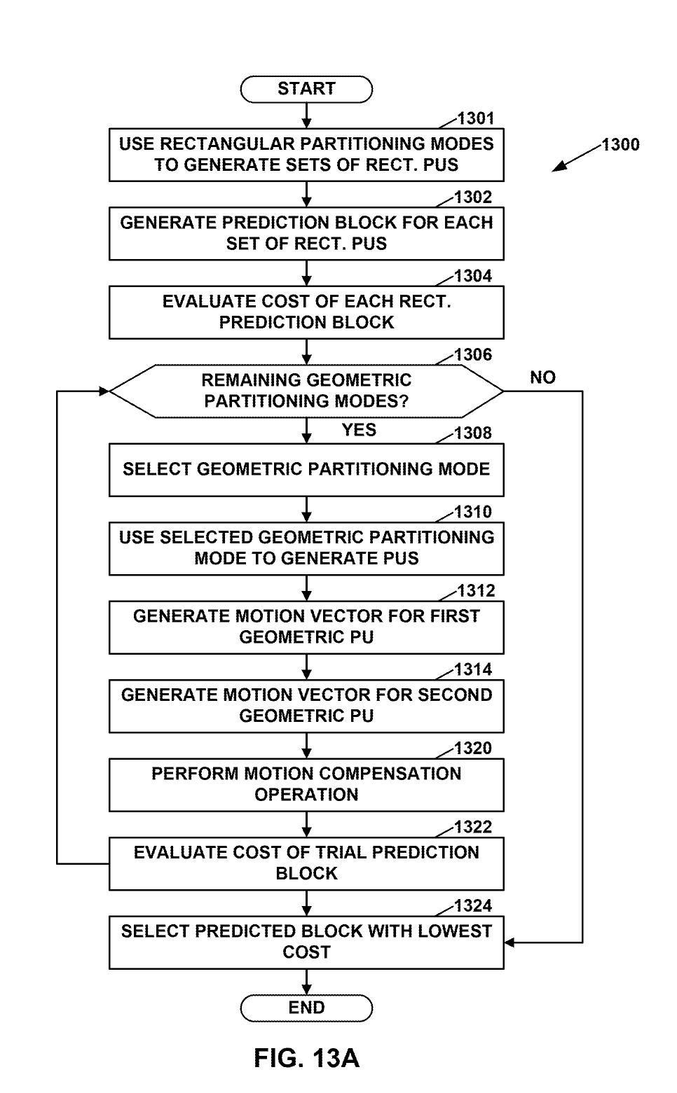

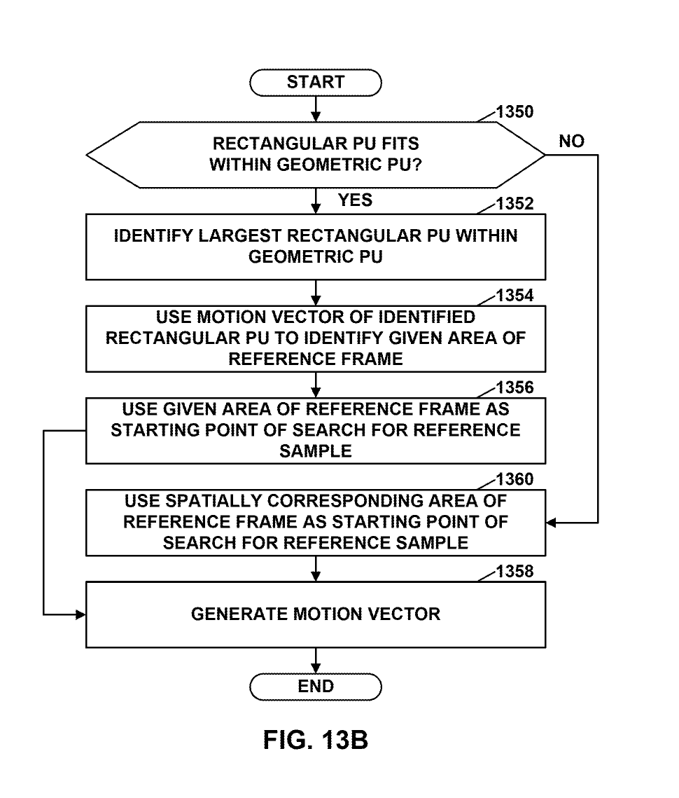

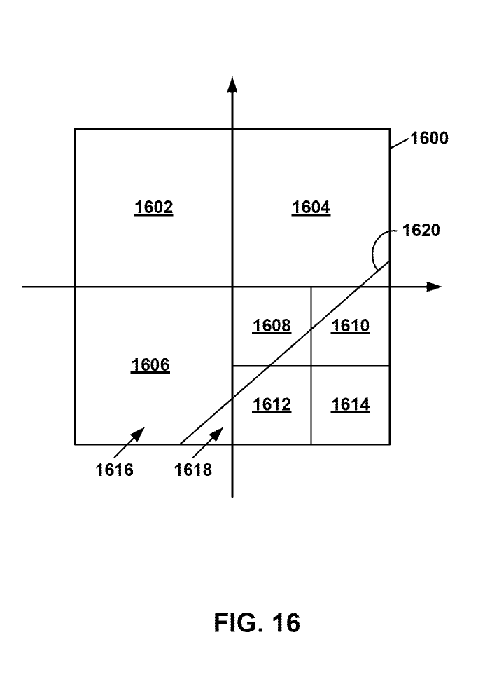

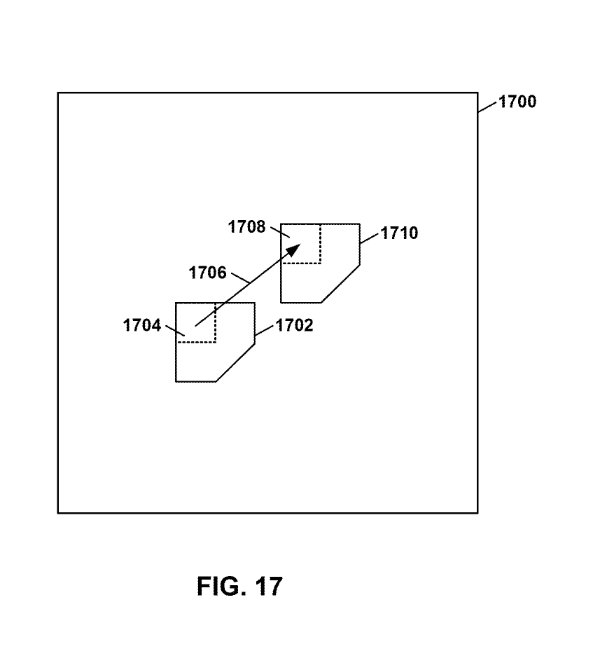

FIG. 13A is a flowchart that illustrates another example operation 1300 performed by inter-prediction unit 304 to generate a prediction block for a CU. Inter-prediction unit 304 may perform operation 1300 as an alternate to either operation 1100 or operation 1200. As mentioned above, it may be computationally complex to determine which of the many available rectangular or geometric partitioning modes produces a prediction block with a lowest rate and/or distortion cost. Operation 1300 may attempt to reduce the computational complexity by re-using motion vectors generated during motion estimation operations for rectangular-partitioned PUs when performing motion estimation operations for geometric-partitioned PUs. FIGS. 16 and 17, described in detail elsewhere in this disclosure, may help illustrate aspects of operation 1300.

After inter-prediction unit 304 starts operation 1300, inter-prediction unit 304 may use a plurality of rectangular partitioning modes to generate sets of rectangular PUs for the CU (1301). The sample block of the CU is rectangularly partitioned among the rectangular PUs within each set of rectangular PUs. For example, inter-prediction unit 304 may use a first rectangular partitioning mode to generate a first and a second rectangular PU for the CU. In this example, the sample block of the CU is rectangularly partitioned between the first and the second PU. In this disclosure, a PU may be considered to be a rectangular PU if the prediction area specified by the prediction tree of the PU is rectangular in shape.

Next, inter-prediction unit 304 may generate a trial prediction block for each set of rectangular PUs (1302). When inter-prediction unit 304 generates a trial prediction block for a set of rectangular PUs, motion estimation unit 602 may generate motion vectors for the rectangular PUs in the set of rectangular PUs. Motion compensation unit 604 may use the motion vectors to generate the trial prediction block. For ease of explanation, this disclosure refers to the trial prediction blocks generated using rectangular PUs as rectangular-partitioned prediction blocks. After generating the rectangular-partitioned prediction blocks, inter-prediction unit 304 evaluates rate and/or distortion costs of each of the rectangular-partitioned prediction blocks (1304).

Next, inter-prediction unit 304 determines whether there are any remaining geometric partitioning modes (1306). If there are one or more remaining geometric partitioning modes (“YES” of 1306), inter-prediction unit 304 selects one of the remaining geometric partitioning modes (1308). After inter-prediction unit 304 selects one of the remaining geometric partitioning modes, the selected geometric partitioning mode is no longer considered to be a remaining geometric partitioning mode. Inter-prediction unit 304 uses the selected geometric partitioning mode to generate two PUs (1310). For ease of explanation, this disclosure may refer to the PUs generated using the selected geometric partitioning mode as the geometric PUs.

After inter-prediction unit 304 generates the geometric PUs, motion estimation unit 604 may generate a motion vector for a first one of the geometric PUs (1312). In some examples, motion estimation unit 604 uses the example operation illustrated in FIG. 13B to generate the motion vector for the first one of the geometric PUs. In addition, motion estimation unit 604 generates a motion vector for a second one of the geometric PUs (1314). In some examples, motion estimation unit 604 uses the example operation illustrated in FIG. 13B to generate the motion vector for the second one of the geometric PUs.

After motion estimation unit 602 has generated the motion vectors for the first and second geometric PUs, motion compensation unit 604 uses the motion vectors for the first and second geometric PUs to perform a motion compensation operation that generates a trial prediction block for the selected geometric partitioning mode (1320). For ease of explanation, this disclosure refers to the trial prediction blocks generated using geometric partitioning modes as geometric-partitioned prediction blocks. Inter-prediction unit 304 may then evaluate a rate and/or distortion cost of the geometric-partitioned prediction block (1322). Inter-prediction unit 304 may then repeat steps 1306-1322 with regard to other geometric partitioning modes.

Once there are no remaining geometric partitioning modes (“NO” of 1306), inter-prediction unit 304 selects one of the rectangular-partitioned or geometric-partitioned prediction blocks with a lowest rate and/or distortion cost as the prediction block for the CU (1324). Subsequently, inter-prediction unit 304 ends operation 1300. As described above, encoding unit 104 may later output encoded data that represents the CU. This encoded data may be based on the prediction block.

In some instances, the operation 1306 implements a method comprising using a first rectangular partitioning mode to generate a first and a second rectangular prediction unit (PU) for a coding unit (CU) in the video data, a sample block of the CU being rectangularly partitioned between the first and the second rectangular PUs. In addition, the method comprises using a geometric partitioning mode to generate a first and a second geometric PU for the CU, the first and second geometric PUs associated with different geometric partitions of the sample block of the CU. Furthermore, the method comprises identifying the first rectangular PU as overlapping the first geometric PU. The method also comprises after identifying the first rectangular PU as overlapping the first geometric PU, using a given area within a reference frame as a starting point for searching the reference frame for a first reference sample, the first reference sample being an area of the reference frame that corresponds to the first geometric PU, a motion vector for the first rectangular PU indicating the given area within the reference frame. The method also comprises generating a prediction block for the CU using the reference sample.

FIG. 13B is a flowchart that illustrates an example portion of operation 1300 to generate a motion vector for a geometric PU. In the example of FIG. 13B, inter-prediction unit 304 determines whether any of the previously-evaluated rectangular PUs have motion vectors and fit entirely within the geometric PU (1350). As used in this disclosure, a rectangular PU fits within a geometric PU if the prediction area of the rectangular PU is sized and positioned such that no portion of the prediction area of the rectangular PU is outside the prediction area of the geometric PU. A rectangular PU may not have a motion vector if the rectangular PU is to be encoded using skip or direct mode.

If any of the previously-evaluated rectangular PUs have motion vectors and fit entirely within the geometric PU (“YES” of 1350), inter-prediction unit 304 identifies a largest one of the rectangular PUs that has a motion vector and fits entirely within the geometric PU (1352). For example, inter-prediction unit 304 may use a first rectangular partitioning mode to generate a first and a second rectangular PU. In this example, the sample block of the CU is rectangularly partitioned between the first and second rectangular PU. Furthermore, in this example, inter-prediction unit 304 may use a second rectangular partitioning mode to generate a third and a fourth rectangular PU. In this example, the sample block of the CU is rectangularly partitioned between the third and the fourth rectangular PU. The first and the third rectangular PUs may fit entirely within the geometric PU. In this example, inter-prediction unit 304 may identify the first rectangular PU as being larger than the third rectangular PU.

After identifying the largest rectangular PU that has a motion vector and fits entirely within the geometric PU, motion estimation unit 602 uses a motion vector of the identified rectangular PU to identify a given area of a reference frame (1354). Motion estimation unit 602 then uses the given area within the reference frame as a starting point of searching the reference frame for a reference sample that corresponds to the geometric PU (1356). Because motion estimation unit 602 is able to use the previously-calculated motion vector to identify the given area as a starting point for searching for the reference sample, it may take fewer computational operations and/or less time for motion estimation unit 602 to find the reference sample for the geometric PU. Motion estimation unit 602 may generate a motion vector for the geometric PU if motion estimation unit 602 finds a portion of the reference frame that corresponds to the geometric PU (1358).

On the other hand, if none of the rectangular PUs that have motion vectors fit entirely within the geometric PU (“NO” of 1350), motion estimation unit 602 may use an area of the reference frame that spatially corresponds to the geometric PU as a starting point for searching the reference frame for a reference sample that corresponds to the geometric PU (1360). Motion estimation unit 602 may then generate a motion vector that indicates a position of the reference sample relative to a position of the geometric PU (1358). For example, motion estimation unit 602 may determine that one of the rectangular PUs fits within the geometric PU, but does not have a motion vector. In this example, motion estimation unit 602 may use an area of the reference frame that spatially corresponds to the geometric PU as a starting point for searching the reference frame for a reference sample that corresponds to the geometric PU. Because motion estimation unit 602 is unable to use a previously-evaluated motion vector as a starting point, it may be more computationally complex for motion estimation unit 602 to perform the motion estimation operation.

In other examples, inter-prediction unit 304 may use a motion vector for a rectangular PU that partially overlaps the geometric PU. The rectangular PU does not necessarily have to fit completely within the geometric PU. Inter-prediction unit 304 may use the motion vector of the rectangular PU to perform a guided motion estimation operation as described above with regard to step 1316.

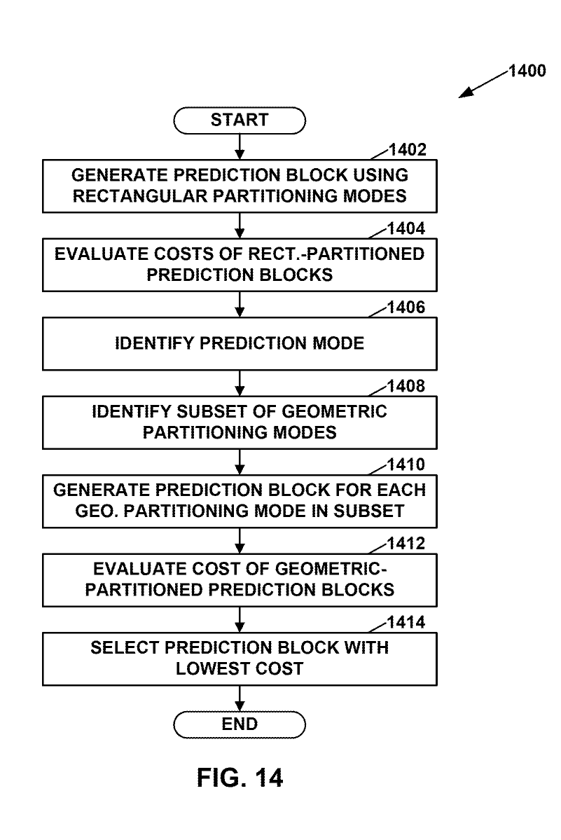

FIG. 14 is a flowchart that illustrates another example operation 1400 performed by inter-prediction unit 304 to generate a prediction block for a CU. Inter-prediction unit 304 may perform operation 1400 as an alternate to operations 1100, 1200, or 1300. As mentioned above, it may be computationally complex to determine which of the rectangular or many geometric partitioning modes produces a prediction block with a lowest rate and/or distortion cost. Operation 1400 may attempt to reduce the computational complexity by evaluating only geometric partitioning modes that are similar to a rectangular partitioning mode that yields a lowest distortion prediction block.

After inter-prediction unit 304 starts operation 1400, inter-prediction unit 304 may generate trial prediction blocks using rectangular partitioning modes (1402). For ease of explanation, this disclosure may refer to the trial prediction blocks generated using the rectangular partitioning modes as rectangular-partitioned prediction blocks. Inter-prediction unit 304 may then evaluate the rate and/or distortion costs of each of the rectangular-partitioned prediction blocks (1404). Inter-prediction unit 304 then identifies a rectangular partitioning mode that yielded the rectangular-partitioned prediction block that has the lowest rate and/or distortion cost (1406).

Inter-prediction unit 304 then identifies a subset of the geometric partitioning modes based on the identified rectangular partitioning mode (1408). In various examples, inter-prediction unit 304 identifies the subset of the geometric partitioning modes in various ways. For example, inter-prediction unit 304 may select values of the theta and rho parameters such that the partitioning lines for the subset of geometric partitioning modes are generally aligned with a partitioning line of the identified rectangular partitioning mode, but differs in angle by a small number of degrees, e.g., 45 degrees on each side of the partitioning line of the identified rectangular partitioning mode. In this example, if the identified rectangular partitioning mode partitions the sample block horizontally, inter-prediction unit 304 may select values of theta from 0 to 45, 135 to 225, and 315 to 360 degrees. In this example, if the identified rectangular partitioning mode partitions the sample block vertically, inter-prediction unit 304 may select values of theta from 45 to 135 and 225 to 315 degrees. In a further example, if the identified rectangular partitioning mode vertically partitions the sample block into two evenly sized partitions, inter-prediction unit 304 may identify values of rho closest to the y-axis, e.g., 0 to 4.

After identifying the subset of the geometric partitioning modes, inter-prediction unit 304 generates prediction blocks using each geometric partitioning mode in the subset (1410). As ease of explanation, this disclosure may refer to the prediction blocks generated using the geometric partitioning modes as geometric-partitioned prediction blocks. Inter-prediction unit 304 then evaluates the rate and/or distortion costs of each of the geometric-partitioned prediction blocks (1412). Inter-prediction unit 304 then selects the rectangular-partitioned or geometric-partitioned prediction block that has the lowest rate and/or distortion cost as the prediction block for the CU (1414). In this way, inter-coding system 304 chooses a partitioning mode without evaluating the rate and/or distortion costs of prediction blocks generated using each geometric partitioning mode.

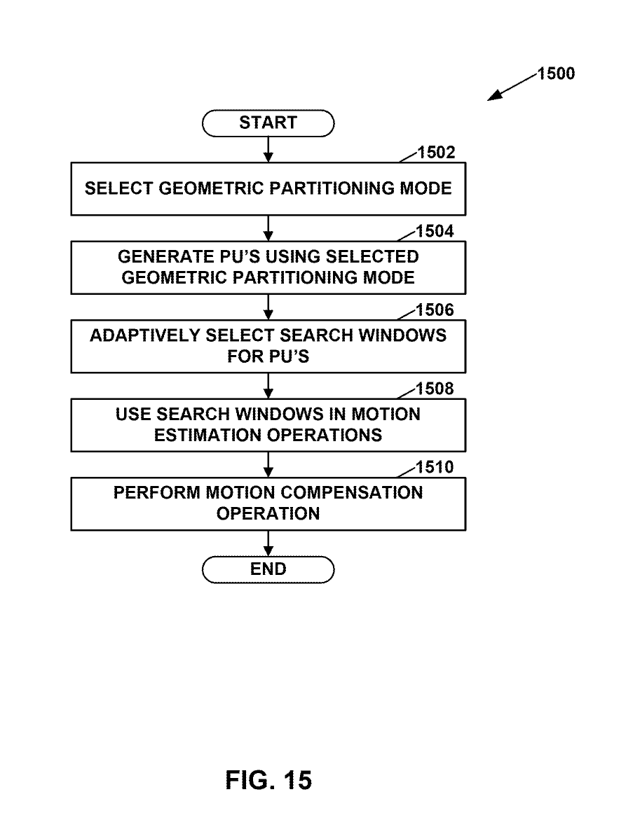

FIG. 15 is a flowchart that illustrates another example operation 1500 performed by inter-prediction unit 304 to generate a prediction block for a CU. Inter-prediction unit 304 may perform operation 1400 as an alternate to operations 1100, 1200, 1300, and 1400 or as part of operations 1100, 1200, 1300, 1400 and other operations. As mentioned above, it may be computationally complex to determine which of the rectangular or many geometric partitioning modes produces a prediction block with a lowest rate and/or distortion cost. Operation 1500 may attempt to reduce the computational complexity by adaptively selecting search windows used when performing motion estimation operations on PUs generated using geometric partitioning modes.

When inter-prediction unit 304 performs operation 1500, inter-prediction unit 304 may select a geometric partitioning mode (1502). In various examples, inter-prediction unit 304 may select the geometric partitioning mode in various ways. For example, inter-prediction unit 304 may select the geometric partitioning mode based on rate and/or distortion costs of prediction blocks generated using various rectangular partitioning modes.

After selecting the geometric partitioning mode, inter-prediction unit 304 may generate PUs for the CU using the selected geometric partitioning mode (1504). For instance, inter-prediction unit 304 may generate PUs for the CU by generating prediction trees of the PUs and linking the prediction trees to the coding node of the CU.

Next, inter-prediction unit 304 may adaptively select search windows for one or more of the PUs (1506). The search windows for the PUs define areas of a reference frame within which motion estimation unit 602 searches for reference samples for the PUs.

In various examples, inter-prediction unit 304 selects the search windows for the PUs based on various criteria. For example, inter-prediction unit 304 may select the search windows based on a resolution of a current video frame. In another example, inter-prediction unit 304 may select the search windows based on values of theta and rho in the selected geometric partitioning mode. In yet another example, inter-prediction unit 304 may select the search windows based on a value of a predicted motion vector. In this example, the predicted motion vector may be predicted from one or more motion vectors of PUs of CUs adjacent to the CU and a co-located block in a temporally previous or future frame.

After selecting the search windows, inter-prediction unit 304 may use the selected search windows to perform motion estimation operations for the PUs (1508). For example, inter-prediction unit 304 may search portions of a reference frame within the selected search windows for reference samples for the PUs. Motion compensation unit 604 may then use motion vectors generated during the motion estimation operations to generate a prediction block for the CU (1510).

As mentioned above, evaluating geometric partitioning modes may be computationally complex. In some examples, the computational complexity of evaluating geometric partitioning modes may be reduced by using a smaller search area when evaluating geometric partitioning modes than when evaluating rectangular partitioning modes. Because the search areas are smaller when evaluating geometric partitioning modes, it may take less time to complete the process of searching the search area for a reference sample for a PU than if the motion estimation unit 602 used the same size search areas for rectangular and geometric partitioning modes. However, when motion estimation unit 602 uses a smaller search area, motion estimation unit 602 may be less likely to identify a corresponding area of the reference frame. A human user or computer program may weigh the effects of this trade-off when setting the search area size used with geometric partitioning modes.

FIG. 16 is a conceptual diagram that illustrates an example sample block 1600. FIG. 16 may help illustrate concepts described with regard to FIGS. 13A and 13B. In the example of FIG. 16, encoding unit 104 has used a rectangular partitioning mode to partition block 1600 into rectangular prediction areas 1602, 1604, 1606, 1608, 1610, 1612, and 1614. Motion estimation unit 602 may generate motion information for prediction areas 1602, 1604, 1606, 1608, 1610, 1612, and 1614.

After motion estimation unit 602 generates motion information for prediction areas 1602, 1604, 1606, 1608, 1610, 1612, and 1614, encoding unit 104 may use a geometric partitioning mode to partition sample block 1600 into a first geometric prediction area 1616 and a second geometric prediction area 1618. A boundary line 1620 separates geometric prediction area 1616 from geometric prediction area 1618.

After encoding unit 104 generates geometric prediction areas 1616 and 1618, encoding unit 104 may determine the largest of previously-generated rectangular prediction area that fits within geometric prediction area 1616 and the largest previously-generated rectangular prediction area that completely overlaps geometric prediction area 1618. In the example of FIG. 16, rectangular prediction area 1602 is the largest rectangular prediction area that completely overlaps geometric prediction area 1616. Rectangular prediction area 1614 is the largest previously-generated prediction area that completely overlaps geometric prediction area 1618.

In accordance with the techniques of this disclosure, motion estimation unit 602 may use the motion information of rectangular prediction area 1602 to identify a first area of a reference frame. Motion estimation unit 602 may then use the first area as a starting point for searching the reference frame for a reference sample that corresponds to geometric prediction area 1616. Similarly, motion estimation unit 602 may use motion information of rectangular prediction area 1614 to identify a second area of the reference frame. Motion estimation unit 602 may then use the second area as a starting point for searching the reference frame for a reference sample that corresponds to geometric prediction area 1618.

FIG. 17 is a conceptual diagram that illustrates searching for a reference sample within a reference frame 1700. In the example of FIG. 17, an area 1702 of reference frame 1700 is collocated with a geometric prediction area in another frame. An area 1704 of reference frame 1700 is collocated with a rectangular prediction area that overlaps the geometric prediction area. A motion vector 1706 of the rectangular prediction area indicates a reference sample 1708 of the rectangular prediction area. An area 1710 of reference frame 1700 is a reference sample for the geometric prediction area. If motion estimation unit 602 initially searched an area around area 1702 for the reference sample for the geometric partition area, more computational operations may performed than if motion estimation unit 602 were to search an area around reference sample 1708.

In one or more examples, the functions described may be implemented in hardware, software, firmware, or any combination thereof. If implemented in software, the functions may be stored on or transmitted as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the invention defined by the following claims.

What is claimed is:

1. A method of encoding video data, the method comprising:
using a first rectangular partitioning mode to generate a first and a second rectangular prediction unit (PU) for a coding unit (CU) in the video data, a sample block of the CU being rectangularly partitioned between the first and the second rectangular PUs;
using a geometric partitioning mode to generate a first and a second geometric PU for the CU, the first and second geometric PUs associated with different geometric partitions of the sample block of the CU;
identifying the first rectangular PU as overlapping the first geometric PU;
after identifying the first rectangular PU as overlapping the first geometric PU, using a motion vector of the first rectangular PU to identify a given area of a reference frame;
using the given area within the reference frame as a starting point for searching the reference frame for a first reference sample, the first reference sample being an area of the reference frame that corresponds to the first geometric PU;
generating a motion vector for the first geometric PU, the motion vector for the first geometric PU indicating a position of the first reference sample relative to a position of the first geometric PU; and
generating a prediction block for the CU using the motion vector for the first geometric PU.

2. The method of claim 1, wherein identifying the first rectangular PU as overlapping the first geometric PU comprises identifying the first rectangular PU as fitting completely within the first geometric PU.

3. The method of claim 2,
wherein the method further comprises using a second rectangular partitioning mode to generate a third and a fourth rectangular PU for the CU, the sample block of the CU rectangularly partitioned between the third and fourth rectangular PUs, the third rectangular PU fitting completely within the first geometric PU; and
wherein identifying the first rectangular PU as fitting completely within the first geometric PU comprises identifying the first rectangular PU as being larger than the third rectangular PU.

4. The method of claim 1, further comprising outputting encoded data that represents the CU, the encoded data based on the prediction block.

5. The method of claim 1, further comprising:
determining that neither the first rectangular PU nor the second rectangular PU fit within the second geometric PU; and
after determining that neither the first rectangular PU nor the second rectangular PU fit within the second geometric PU, using an area of the reference frame that spatially corresponds to the second geometric PU as a starting point for searching the reference frame for a second reference sample, the second reference sample being an area of the reference frame that corresponds to the second geometric PU.

6. The method of claim 1,
determining that the second rectangular PU fits within the second geometric PU, the second rectangular PU not having a motion vector; and
after determining that the second rectangular PU fits within the second geometric PU, using an area of the reference frame that spatially corresponds to the second geometric PU as a starting point for searching the reference frame for a second reference sample, the second reference sample being an area of the reference frame that corresponds to the second geometric PU.

7. A computing device that comprises a processor configured to:
use a first rectangular partitioning mode to generate a first and a second rectangular prediction unit (PU) for a coding unit (CU) in video data, a sample block of the CU being rectangularly partitioned between the first and the second rectangular PUs;
use a geometric partitioning mode to generate a first and a second geometric PU for the CU, the first and second geometric PUs associated with different geometric partitions of the sample block of the CU;
identify the first rectangular PU as overlapping the first geometric PU;
after identifying the first rectangular PU as overlapping the first geometric PU, use a motion vector of the first rectangular PU to identify a given area of a reference frame;
use the given area within the reference frame as a starting point for searching the reference frame for a first reference sample, the first reference sample being an area of the reference frame that corresponds to the first geometric PU;
generate a motion vector for the first geometric PU, the motion vector for the first geometric PU indicating a position of the first reference sample relative to a position of the first geometric PU; and
generate a prediction block for the CU using the motion vector for the first geometric PU.

8. The computing device of claim 7, wherein the processor is configured to identify the first rectangular PU as overlapping the first geometric PU when the first rectangular PU fits completely within the first geometric PU.

9. The computing device of claim 7, wherein the processor is configured to:
use a second rectangular partitioning mode to generate a third and a fourth rectangular PU for the CU, the sample block of the CU rectangularly partitioned between the third and fourth rectangular PUs, the third rectangular PU fitting completely within the first geometric PU; and
identify the first rectangular PU as being a larger than the third rectangular PU.

10. The computing device of claim 7, wherein the processor is configured to output encoded data that represents the CU, the encoded data based on the prediction block.

11. The computing device of claim 7, wherein the processor is configured to:
determining that neither the first rectangular PU nor the second rectangular PU fit within the second geometric PU; and
use an area of the reference frame that spatially corresponds to the second geometric PU as a starting point for searching the reference frame for a second reference sample, the second reference sample being an area of the reference frame that corresponds to the second geometric PU.

12. The computing device of claim 7, wherein the processor is configured to:
determine that the second rectangular PU fits within the second geometric PU, the second rectangular PU not having a motion vector; and
use an area of the reference frame that spatially corresponds to the second geometric PU as a starting point for searching the reference frame for a second reference sample, the second reference sample being an area of the reference frame that corresponds to the second geometric PU.

13. A computing device comprising:
means for using a first rectangular partitioning mode to generate a first and a second rectangular prediction unit (PU) for a coding unit (CU) in the video data, a sample block of the CU being rectangularly partitioned between the first and the second rectangular PUs;
means for using a geometric partitioning mode to generate a first and a second geometric PU for the CU, the first and second geometric PUs associated with different geometric partitions of the sample block of the CU;
means for identifying the first rectangular PU as overlapping the first geometric PU;
means for using a motion vector of the first rectangular PU to identify a given area of a reference frame after identifying the first rectangular PU as overlapping the first geometric PU;
means for using the given area within the reference frame as a starting point for searching the reference frame for a first reference sample, the first reference sample being an area of the reference frame that corresponds to the first geometric PU;
means for generating a motion vector for the first geometric PU, the motion vector for the first geometric PU indicating a position of the first reference sample relative to a position of the first geometric PU; and
means for generating a prediction block for the CU using the motion vector for the first geometric PU.

14. The computing device of claim 13, comprising means for identifying the first rectangular PU as fitting completely within the first geometric PU.

15. The computing device of claim 13, comprising:
means for determining that neither the first rectangular PU nor the second rectangular PU fit within the second geometric PU; and
means for using an area of the reference frame that spatially corresponds to the second geometric PU as a starting point for searching the reference frame for a second reference sample, the second reference sample being an area of the reference frame that corresponds to the second geometric PU.

16. The computing device of claim 13, comprising:
means for determining that the second rectangular PU fits within the second geometric PU, the second rectangular PU not having a motion vector; and
means for using an area of the reference frame that spatially corresponds to the second geometric PU as a starting point for searching the reference frame for a second reference sample, the second reference sample being an area of the reference frame that corresponds to the second geometric PU.

17. A computer program product that comprises a computer-readable storage medium having instructions stored thereon that cause one or more processors to:
use a first rectangular partitioning mode to generate a first and a second rectangular prediction unit (PU) for a coding unit (CU) in the video data, a sample block of the CU being rectangularly partitioned between the first and the second rectangular PUs;
use a geometric partitioning mode to generate a first and a second geometric PU for the CU, the first and second geometric PUs associated with different geometric partitions of the sample block of the CU;
identify the first rectangular PU as overlapping the first geometric PU;
after identifying the first rectangular PU as overlapping the first geometric PU, use a motion vector of the first rectangular PU to identify a given area of a reference frame;
use the given area within the reference frame as a starting point for searching the reference frame for a first reference sample, the first reference sample being an area of the reference frame that corresponds to the first geometric PU;
generate a motion vector for the first geometric PU, the motion vector for the first geometric PU indicating a position of the first reference sample relative to a position of the first geometric PU; and
generate a prediction block for the CU using the motion vector for the first geometric PU.

18. The computer program product of claim 17, wherein the program instructions configure the processor to identify the first rectangular PU as overlapping the first geometric PU comprises identifying the first rectangular PU as fitting completely within the first geometric PU.

19. The computer program product of claim 17, wherein the program instructions configure the processor to:
determine that neither the first rectangular PU nor the second rectangular PU fit within the second geometric PU; and
after determining that neither the first rectangular PU nor the second rectangular PU fit within the second geometric PU, use an area of the reference frame that spatially corresponds to the second geometric PU as a starting point for searching the reference frame for a second reference sample, the second reference sample being an area of the reference frame that corresponds to the second geometric PU.

20. The computer program product of claim 17, wherein the program instructions configure the processor to:
determine that the second rectangular PU fits within the second geometric PU, the second rectangular PU not having a motion vector; and
after determining that the second rectangular PU fits within the second geometric PU, use an area of the reference frame that spatially corresponds to the second geometric PU as a starting point for searching the reference frame for a second reference sample, the second reference sample being an area of the reference frame that corresponds to the second geometric PU.
